(19) United States
(12) Patent Application Publication
(10) Pub. No.: US 2017/0246786 A1
(43) Pub. Date: Aug. 31, 2017

(54) PATTERNED MICROPOROUS BREATHABLE FILM AND METHOD OF MAKING THE PATTERNED MICROPOROUS BREATHABLE FILM

(71) Applicant: Berry Plastics Corporation, Evansville, IN (US)

(72) Inventors: Jeffrey A. MIDDLESWORTH, Wauconda, IL (US); Martin F. HOENIGMANN, Chippewa Falls, WI (US)

(21) Appl. No.: 15/442,867

(22) Filed: Feb. 27, 2017

Related U.S. Application Data
(60) Provisional application No. 62/301,167, filed on Feb. 29, 2016.

(51) Int. Cl. B29C 47/00; B29C 47/88; B29C 55/14; B29C 47/34

(52) U.S. Cl. CPC B29C 47/0061; B29C 47/0057; B29C 47/0021; B29C 47/34; B29C 47/8805; B29C 47/8845; B29C 55/146; B29K 2023/0625

(57) ABSTRACT

Microporous breathable films include a polyolefin and an inorganic filler dispersed in the polyolefin.

### PRIORITY CLAIM

This application claims priority under 35 U.S.C. §119(e) to U.S. Provisional Application Ser. No. 62/301,167, filed Feb. 29, 2016, which is expressly incorporated by reference herein.

### BACKGROUND

The present disclosure relates to polymeric materials, and particularly to polymeric films. More particularly, the present disclosure relates to microporous breathable films formed from polymeric material.

### SUMMARY

According to the present disclosure, a microporous breathable film is made using a manufacturing process. The manufacturing process comprises the steps of extruding a composition to form a molten web, casting the molten web to form a quenched film, and stretching the quenched film to form the microporous breathable film.

In illustrative embodiments, the composition extruded to form the molten web comprises a polyolefin, an inorganic filler, and a pigment. The quenched film is formed by casting the molten web against a surface of a chill roll using a vacuum box and/or blowing air (e.g., an air knife and/or an air blanket).

In illustrative embodiments, a patterned microporous breathable film comprising a polyolefin, an inorganic filler, and a pigment has a basis weight of less than about 14 gsm. The patterned microporous breathable film also has a Dart Impact Strength of at least about 75 grams.

In illustrative embodiments, a patterned multi-layer microporous breathable film comprises at least one microporous breathable film layer according to the present disclosure and at least one additional layer. The at least additional layer comprises a polyolefin.

In illustrative embodiments, a patterned multi-layer breathable barrier film comprises at least one patterned microporous breathable film layer according to the present disclosure and at least one moisture-permeable barrier layer. The at least one moisture-permeable barrier layer comprises a hygroscopic polymer.

In illustrative embodiments, a personal hygiene product comprises at least one patterned microporous breathable film and at least one outer non-woven layer. The at least one patterned microporous breathable film is configured to contact skin and/or clothing of a user of the personal hygiene product.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The patent or application file contains at least one drawing executed in color. Copies of this patent or patent application publication with color drawing(s) will be provided by the office upon request and payment of the necessary fee.

The detailed description particularly refers to the accompanying figures in which:

FIG. 1 is a diagrammatic view of a representative embodiment of a microporous breathable film that includes one layer;

FIG. 2 is a diagrammatic view of an exemplary process for machine direction (MD) stretching of a polymeric film;

FIG. 3 is a diagrammatic view of an exemplary process for cross-directional (CD) stretching of a polymeric film;

FIG. 4 is a diagrammatic view of an exemplary process for intermeshing gears (IMG) stretching of a polymeric film;

FIG. 5 is a diagrammatic view of a representative embodiment of a patterned microporous breathable film that includes a core layer and two skin layers;

FIG. 6 is a photograph of a representative embodiment of a patterned microporous breathable film that includes a grey pigment in a core layer;

FIG. 7 is a photograph of a representative embodiment of a patterned microporous breathable film that includes a grey pigment in a skin layer;

FIG. 8 is a diagrammatic view of an exemplary process for casting a molten web against a chill roll using a vacuum box;

FIG. 9 is a diagrammatic view of an exemplary process for casting a molten web against a chill roll using an air knife;

FIG. 10 is a diagrammatic view of an exemplary process for casting a molten web against a chill roll using a vacuum box and an air knife, stretching the quenched film by CD IMG, post-stretching the CD IMG-stretched film in a machine direction, and annealing the stretched film;

FIG. 11 is a diagrammatic view of a representative embodiment of a patterned multi-layer microporous breathable barrier film that includes three layers;

FIG. 12 is a diagrammatic view of a representative embodiment of a patterned microporous breathable film that includes one layer; and

FIG. 13 is a diagrammatic view of a representative embodiment of a patterned microporous breathable film that includes a core layer and two skin layers

### DETAILED DESCRIPTION

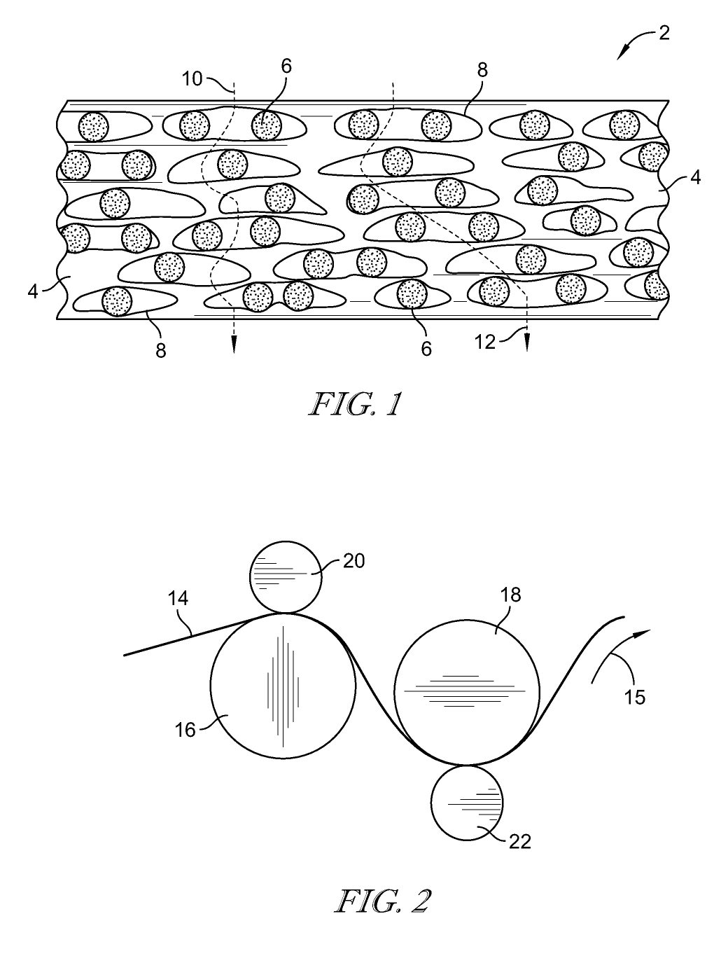

A first embodiment of a microporous breathable film 2 in accordance with the present disclosure is shown, for example, in FIG. 1. Microporous breathable film 2 includes a thermoplastic polymer 4 and a solid filler 6 dispersed in the thermoplastic polymer 4. In some embodiments, the microporous breathable film 2 further includes one or more pigments (not shown) dispersed in the thermoplastic polymer 4, such that the microporous breathable film 2 is patterned, as further described below. In some embodiments, the microporous breathable film 2 includes a combination of two or more thermoplastic polymers 4 and/or a combination of two or more solid fillers 6 and/or a combination of two or more pigments (not shown). As shown in FIG. 1, the microporous breathable film 2 includes an interconnected network of micropores 8 formed in the thermoplastic polymer resin 4. On average, the micropores 8 are smaller in size than the size of a typical water droplet but larger in size than a water vapor molecule. As a result, the micropores 8 permit the passage of water vapor but minimize or block the passage of liquid water. Two representative pathways for the transmission of water vapor through the microporous breathable film 2 are shown by the dashed lines 10 and 12 in FIG. 1.

A precursor film containing a thermoplastic polymer 4, a solid filler 6 dispersed in the thermoplastic polymer 4, and a pigment (not shown) may be produced by either a cast film process or a blown film process. The film thus produced may then be stretched by one or more stretching processes. The stretching process moves (e.g., pulls) polymeric material away from the surface of solid filler dispersed therein, thereby forming the micropores 8. Moreover, as further described below, the pigment-containing film may, upon stretching, form a pattern in the film. In illustrative embodiments, the pattern resembles seersucker fabric.

In one example, stretching may be achieved via machine direction (MD) orientation by a process analogous to that shown in simplified schematic form in FIG. 2. For example, the film 14 shown in FIG. 2 may be passed between at least two pairs of rollers in the direction of an arrow 15. In this example, first roller 16 and a first nip 20 run at a slower speed (V₁) than the speed (V₂) of a second roller 18 and a second nip 22. The ratio of V₂/V₁ determines the degree to which the film 14 is stretched. Since there may be enough drag on the roll surface to prevent slippage, the process may alternatively be run with the nips open. Thus, in the process shown in FIG. 2, the first nip 20 and the second nip 22 are optional.

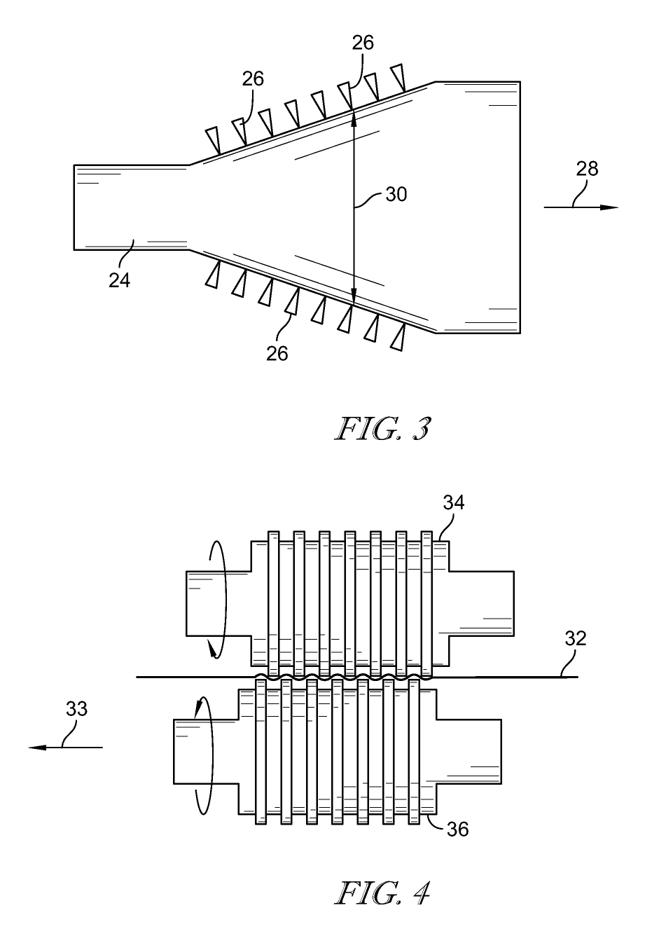

In another example, stretching may be achieved via transverse or cross-directional (CD) stretching by a process analogous to that shown in simplified schematic form in FIG. 3. For example, the film 24 shown in FIG. 3 may be moved in the direction of the arrow 28 while being stretched sideways on a tenter frame in the directions of doubled-headed arrow 30. The tenter frame includes a plurality of attachment mechanisms 26 configured for gripping the film 24 along its side edges.

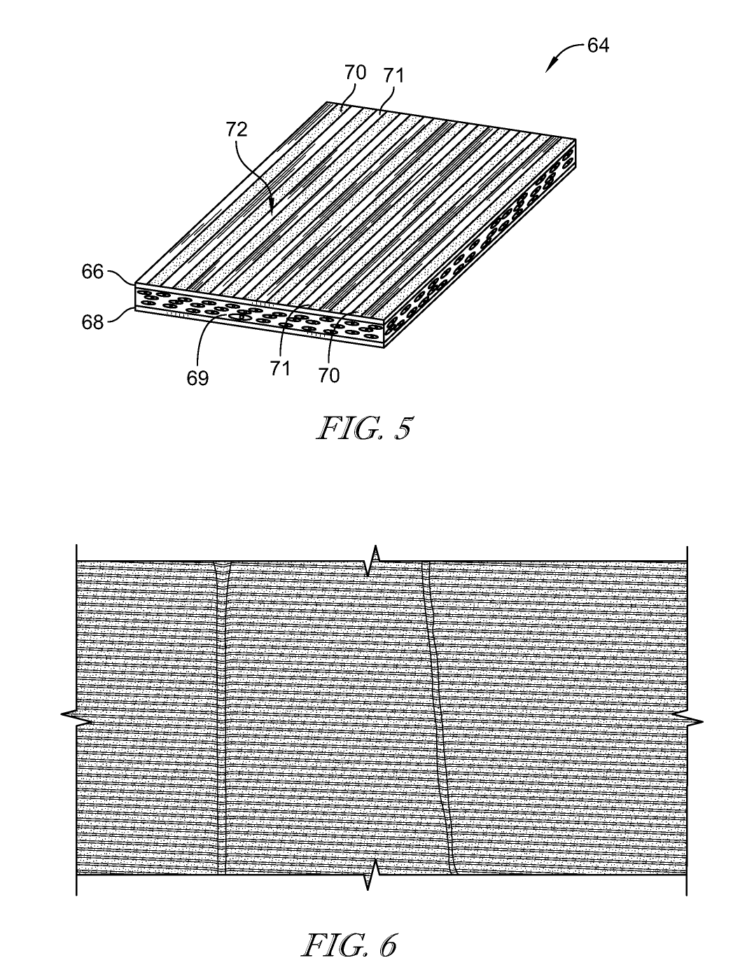

In a further example, stretching may be achieved via intermeshing gears (IMG) stretching by a process analogous to the one shown in simplified schematic form in FIG. 4. For example, a film 32 may be moved between a pair of grooved or toothed rollers as shown in FIG. 4 in the direction of arrow 33. In one example, the first toothed roller 34 may be rotated in a clockwise direction while the second toothed roller 36 may be rotated in a counterclockwise direction. At each point at which one or more teeth of the rollers 34 and 36 contact the film 32, localized stresses may be applied that stretch the film 32 and introduce interconnecting micropores therein analogous to the micropores 8 shown in FIG. 1. By the use of IMG stretching, the film 32 may be stretched in the machine direction (MD), the cross direction (CD), at oblique angles to the MD, or in any combination thereof.

A precursor film containing a thermoplastic polymer 4, a solid filler 6 dispersed in the polymer 4, and a pigment that is stretched to form a patterned microporous breathable film 2 in accordance with the present disclosure may be prepared by mixing together the thermoplastic polymer 4 (or a combination of thermoplastic polymers 4), the solid filler 6 (or a combination of solid fillers), a pigment (or a combination of pigments), and any optional components until blended, heating the mixture, and then extruding the mixture to form a molten web. A suitable film-forming process may be used to form a precursor film en route to forming a patterned microporous breathable film. For example, the precursor film may be manufactured by casting or extrusion using blown-film, co-extrusion, or single-layer extrusion techniques and/or the like. In one example, the precursor film may be wound onto a winder roll for subsequent stretching in accordance with the present disclosure. In another example, the precursor film may be manufactured in-line with a film stretching apparatus such as shown in one or more of FIGS. 2-4.

In addition to containing one or more thermoplastic polymers and solid filler, the precursor film may also contain other optional components to improve the film properties or processing of the film. Representative optional components include, but are not limited to, anti-oxidants (e.g., added to prevent polymer degradation and/or to reduce the tendency of the film to discolor over time) and processing aids (e.g., added to facilitate extrusion of the precursor film). In one example, the amount of one or more anti-oxidants in the precursor film is less than about 1% by weight of the film and the amount of one or more processing aids is less than about 5% by weight of the film. Additional optional additives include but are not limited to whitening agents (e.g., titanium dioxide), which may be added to increase the opacity of the film. In one example, the amount of one or more whitening agents is less than about 10% by weight of the film. Further optional components include but are not limited to antiblocking agents (e.g., diatomaceous earth) and slip agents (e.g. erucamide a.k.a. erucylamide), which may be added to allow film rolls to unwind properly and to facilitate secondary processing (e.g., diaper making). In one example, the amount of one or more antiblocking agents and/or one or more slip agents is less than about 5% by weight of the film. Further additional optional additives include but are not limited to scents, deodorizers, pigments other than white, noise reducing agents, and/or the like, and combinations thereof. In one example, the amount of one or more scents, deodorizers, pigments other than white, and/or noise reducing agents is less than about 10% by weight of the film.

Prior to stretching, the precursor film may have an initial basis weight of less than about 100 grams per square meter (gsm). In one example, the precursor film has an initial basis weight of less than about 75 gsm. The precursor film may be a monolayer film, in which case the entire precursor film comprises the thermoplastic polymer (or combination of thermoplastic polymers), solid filler (or combination of solid fillers), and pigment (or combination of pigments). In another example, the precursor film may be a multilayer film as suggested in FIGS. 5 and 11.

In one example, a patterned microporous breathable film 2 in accordance with the present disclosure is formed via a blown film process. In another example, a patterned microporous breathable film 2 in accordance with the present disclosure is formed via a cast film process. The cast film process involves the extrusion of molten polymers through an extrusion die to form a thin film. The film is pinned to the surface of a chill roll with an air knife, an air blanket, and/or a vacuum box. Alternatively, the film is subjected to an embossing process on a patterned chill roll. A precursor film—regardless of how it is formed (e.g., via a cast film process using an air knife, an air blanket, and/or a vacuum box; via a nipped embossing process; etc.) may be subsequently patterned through a stretching processes in accordance with the present disclosure.

In illustrative embodiments, a process for making a patterned microporous breathable film 2 in accordance with the present disclosure includes (a) extruding a composition containing a thermoplastic polymer 4, a solid filler 6, and a pigment (not shown) to form a molten web, (b) casting the molten web against a surface of a chill roll to form a quenched film, and (c) stretching the quenched film to form the patterned microporous breathable film 2.

It has been discovered that by including a pigment in a composition to be extruded, the stretching process—which moves (e.g., pulls) polymeric material away from the surface of solid filler dispersed therein, thereby forming the micropores 8—may also result in the formation of a pattern in the stretched film (e.g., a pattern of alternating stripes—for example, a pattern of alternating light and dark stripes). In illustrative embodiments, the stretching process includes CD IMG stretching of a type shown in FIG. 4. In a CD IMG stretching process, the lanes of material that are stretched between the CD IMG roller teeth tend to whiten due to cavitation. By contrast, the adjacent lanes of material that ride on top of the teeth tend not to stretch or cavitate (or to stretch and/or cavitate to a lesser extent than the adjacent lanes), thereby exhibiting a darker color. In illustrative embodiments, the pattern that tends to form in a pigment-containing film subjected to CD IMG stretching is an alternation of dark-light-dark-light stripes, which resembles a seersucker fabric.

FIG. 5 shows a representative seersucker pattern 72 of a patterned microporous breathable film 64 in accordance with the present disclosure. As shown in FIG. 5, the seersucker pattern 72 includes alternating light stripes 71 and dark stripes 70. In the example shown in FIG. 5, the patterned microporous breathable film 64 includes a microporous breathable film core layer 69, which is analogous to the patterned microporous breathable film 2 shown in FIG. 1 and which is disposed between a first skin layer 66 and a second skin layer 68. As further explained below, one or more pigments may be contained in one or more of the microporous breathable film core layer 69, the first skin layer 66, and/or the second skin layer 68. Although more than one pigment may be used in accordance with the present disclosure, the use of only a single pigment (e.g., provided in either the microporous breathable core layer 69 or in one or both of the first skin layer 66 and the second skin layer 68) will suffice to impart the seersucker pattern 72.

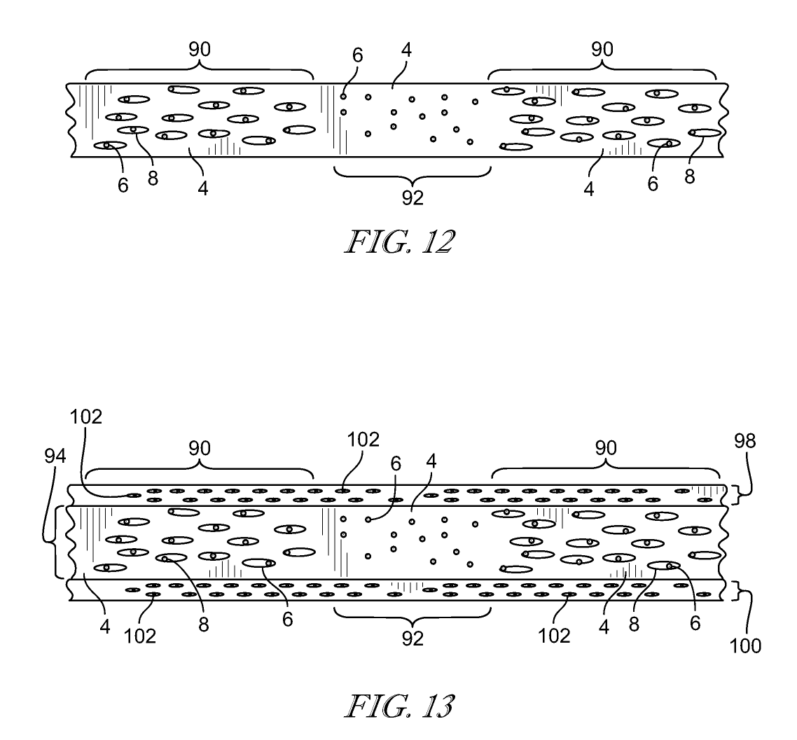

The seersucker pattern shown in FIG. 5 may be achieved in different ways. For example, as shown in FIG. 12, a stretching process that includes CD IMG stretching of a type shown in FIG. 4 may be applied to a film 94 that includes a thermoplastic polymer 4 and a solid filler 6 dispersed in the thermoplastic polymer 4. In the CD IMG stretching process, the lanes 90 of the film 94 that are stretched between the CD IMG roller teeth tend to whiten due to cavitation. The micropores 8 thereby created around the solid filler 6 in the lanes 90 may refract light and thus add opacity to the film 94 in lanes 90. By contrast, the adjacent lanes 92 of the film 94 that ride on top of the teeth tend not to stretch or cavitate (or to stretch and/or cavitate to a lesser extent than the adjacent lanes 90), such that the thermoplastic polymer 4 tends not to separate from the solid filler 6 in the lanes 92. As a result, the lanes 92 do not block much light and appear to be translucent, thus exhibiting a darker, more intense color. The alternation of opaque lanes 90 and translucent lanes 92 may be achieved even in the absence of any pigment dispersed in the thermoplastic polymer 4. However, the visual effect is more pronounced when at least one pigment is present. Thus, in some embodiments, one or more pigments are provided in a composition to be extruded that already contains a thermoplastic polymer and a solid filler. In other words, the pigment may be provided in the layer in which the micropores are formed (e.g., in the microporous breathable film core layer 69 shown in FIG. 5). FIG. 6 shows a photograph of a patterned microporous breathable film obtained by putting a grey color concentrate pigment in a core layer containing CaCO₃ solid filler.

Alternatively, or in addition, a pigment may also be provided in one or more non-core layers (e.g., the first skin layer 66 and/or the second skin layer 68 shown in FIG. 5) that are devoid of solid filler. By way of example, a stretching process that includes CD IMG stretching of a type shown in FIG. 4 may be applied to a skinned film 96 that is analogous to the film 94 shown in FIG. 12. In some embodiments, as shown in FIG. 13, the film 96 includes a core film layer 94 analogous to that shown in FIG. 12, which is dispersed between a first skin layer 98 and a second skin layer 100. As shown in FIG. 13, each of the first skin layer 98 and the second skin layer 100 may include a pigment 102. In the CD IMG stretching process, the lanes 90 of the core layer 94 that are stretched between the CD IMG roller teeth tend to whiten due to cavitation, as described above in reference to FIG. 12. The lanes 90 of the core layer 94 provide a white background underneath the pigment-containing first skin layer 98 and the pigment-containing second skin layer 100, thereby changing the appearance of the skin layers in the region of the film 96 corresponding to the lanes 90. By contrast, the adjacent lanes 92 of the core layer 94 that ride on top of the teeth tend not to stretch or cavitate, as described above in reference to FIG. 12, such that the lanes 92 appear to be translucent and do not substantially change the appearance of the pigment-containing first skin layer 98 and the pigment-containing second skin layer 100 in the region of the film 96 corresponding to the lanes 92. Thus, the regions of the film 96 corresponding to the lanes 92 will appear dark as compared to the regions of the film 96 corresponding to the lanes 90.

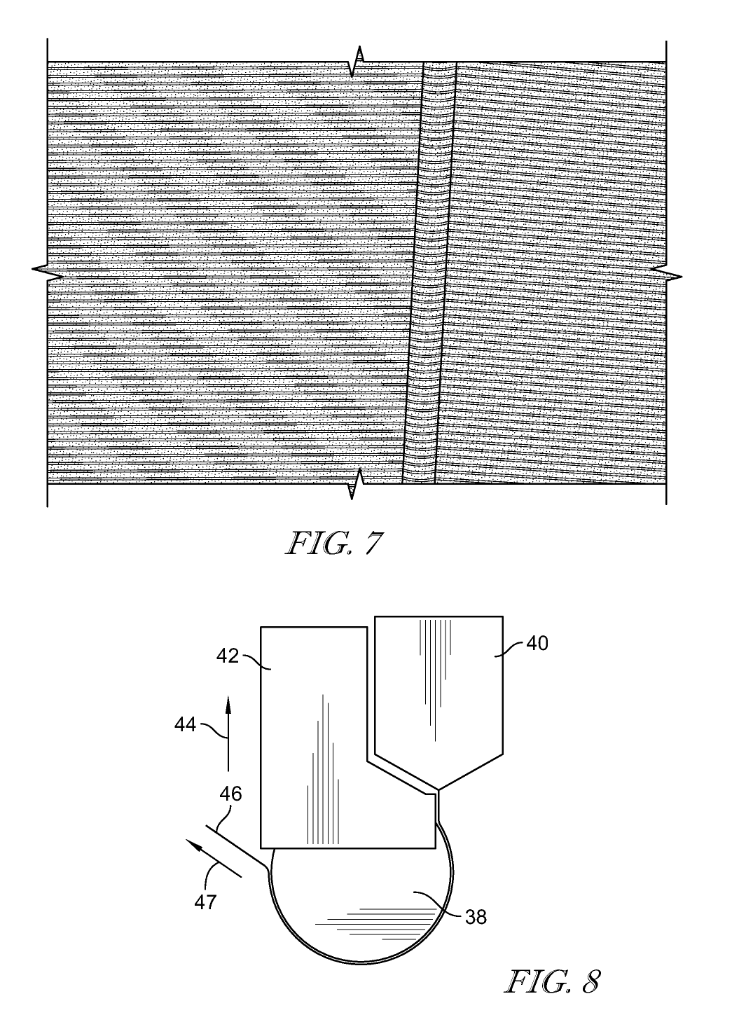

FIG. 7 shows a photograph of a patterned microporous breathable film obtained by putting a grey color concentrate pigment in the unfilled LDPE outer skin layers (e.g., Example 7 described below). The pigment-containing outer skin layers in FIG. 7 each represent only about 1.5% of the total thickness of the film. As shown in FIG. 7, the cavitation that occurs in the pigment-free, CaCO₃-containing core layer underlying the pigment-containing, unfilled outer skin layers suffices to impart an alternating pattern of white and translucent lanes beneath the colored outer skin layer, which imparts an overall seersucker pattern to the film (albeit one that is not as pronounced as compared to FIG. 6). When two or more pigments are included in a composition to be extruded in accordance with the present disclosure, the pigments may be the same or different.

In accordance with the present disclosure, the casting of the molten web against a surface of a chill roll to form a quenched film may be achieved in various ways. In illustrative embodiments, a vacuum box, blowing air (e.g., an air knife and/or an air blanket), or a vacuum box in combination with blowing air to form a quenched film may be used to cast the molten web against the chill roll. In thin film applications, the use of a vacuum box and/or blowing air may avoid the phenomenon of draw resonance that may arise in embossing processes. However, for applications requiring thicker films (e.g., basis weights greater than about 75 gsm in the case of a polypropylene film), draw resonance may not be a problem, and the quenched film may instead be formed by an embossing process.

It has been discovered that by using a vacuum box, blowing air (e.g., an air knife and/or an air blanket), or a vacuum box in combination with blowing air to cast the molten web against a chill roll in accordance with the present disclosure, patterned microporous breathable films 2 exhibiting surprisingly and unexpectedly improved properties as compared to other patterned microporous breathable films may be prepared. As further described below, these properties may include reduced basis weight, increased Dart Impact Strength, increased strain at peak machine direction, and/or the like, and combinations thereof.

Representative techniques for casting a molten web against a surface of a chill roll to form a quenched film in accordance with the present disclosure are described below.

In one example, the molten web is cast against the surface of the chill roll under negative pressure using a vacuum box as shown in simplified schematic form in FIG. 8. A vacuum box works by evacuating air between the film and the surface of the chill roll. For example, as shown in FIG. 8, a film 46 is extruded from an extrusion die 40 in the direction of arrow 47 and quenched from the molten state with a vacuum box 42. The vacuum box 42 draws a vacuum behind the molten web 46 in the direction of arrow 44 to draw the film 46 down onto the chill roll 38. The vacuum drawn in the direction of arrow 44 removes the entrained air between the surface of the chill roll 38 and the film 46. The vacuum box process is not subject to draw resonance for high molecular weight polymers that would tend to extrude unstable thickness in a nipped quench process due to the draw resonance phenomenon.

When a vacuum box 42 is used, the molten polymer may exit the die 40 and hit the chill roll 38 within a smaller distance than in an embossed process. For example, in some embodiments, the melt curtain is configured to hit the chill roll 38 within a distance of less than about 12 inches, 11 inches, 10 inches, 9 inches, 8 inches, 7 inches, 6 inches, 5 inches, 4 inches, 3, inches, 2 inches, or 1 inch. In illustrative embodiments, the melt curtain is configured to exit the die and hit the roll within a distance of less than about 3 inches and, in some examples, within a distance of about or less than 1 inch. One advantage of reducing the distance between the die 40 and the roll surface 38 as compared to in a nipped quench process is that smaller distances are less susceptible to the phenomenon of neck-in. Neck-in refers to a reduction in width of the molten web that occurs as the web leaves the die. By drawing the film 46 onto a surface of the chill roll 38 over a short distance as shown in FIG. 8, the vacuum box 42 may enhance web cooling, facilitate higher line speeds, reduce film neck-in, and/or reduce drag at the lip exit.

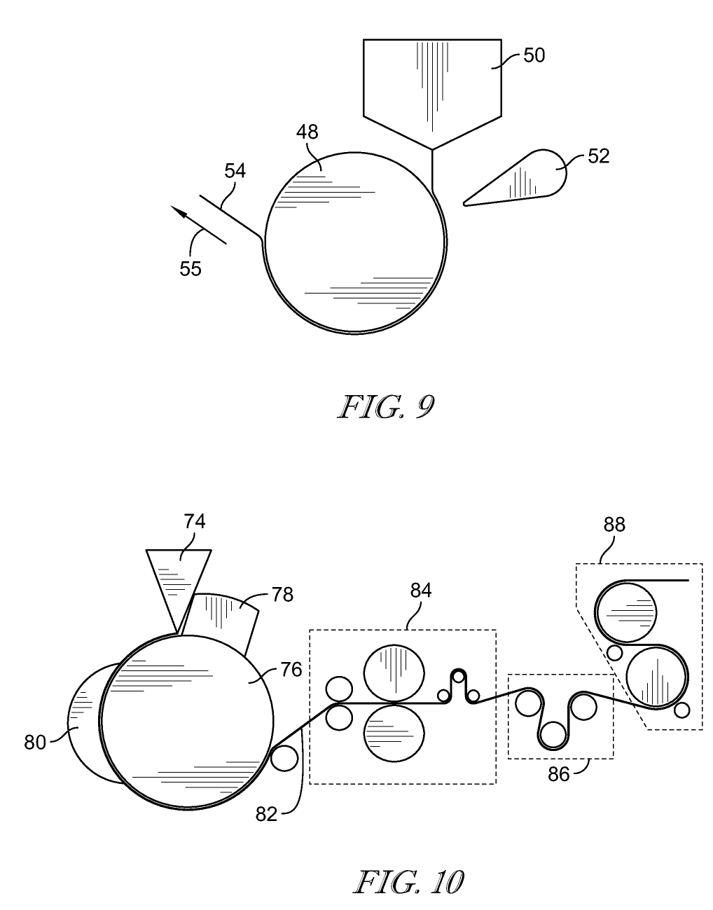

In another example, the molten web is cast against the surface of the chill roll under positive pressure using an air knife or air blanket, as shown in simplified schematic form in FIG. 9. An air knife works to promote web quenching by gently blowing a high-velocity, low-volume air curtain over the molten film, thereby pinning the molten film to the chill roll for solidification. For example, as shown in FIG. 9, a film 54 is extruded from an extrusion die 50 in the direction of arrow 55 and quenched from the molten state with an air knife 52 blowing an air curtain over the molten film 54, thereby pinning the molten web 54 against a surface of the chill roll 48. An air blanket (a.k.a. soft box) works similarly to an air knife and promotes web quenching by gently blowing an air curtain over the molten film. However, in the case of an air blanket, the air curtain is low velocity and high volume.

In a further example, the molten web is cast against the surface of the chill roll under a combination of negative pressure from a vacuum box, as shown in FIG. 8, and positive pressure from an air knife, as shown in FIG. 9. In illustrative embodiments, in the casting of the molten web against a surface of the chill roll, an exit temperature of cooling fluid passing through the chill roll is between about 50 degrees Fahrenheit and about 130 degrees Fahrenheit and, in some examples, between about 75 degrees Fahrenheit and about 130 degrees Fahrenheit.

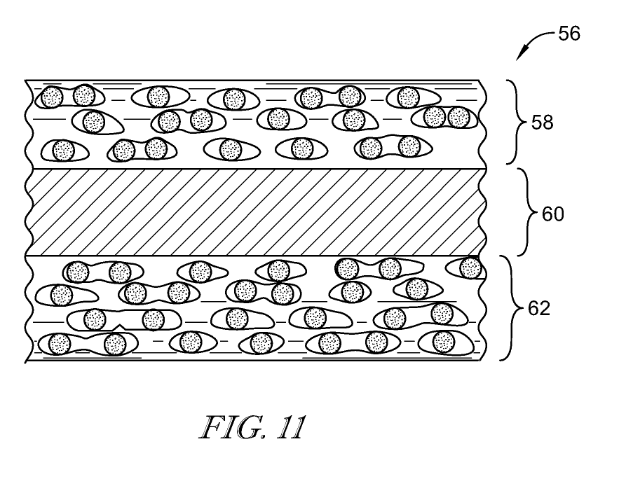

In illustrative embodiments, a process for making a patterned microporous breathable film 2 in accordance with the present disclosure may be executed as shown in simplified schematic form in FIG. 10. The process includes extruding a composition containing a thermoplastic polymer 4, a solid filler 6, and a pigment (not shown) from a die 74 to form a molten web. The molten web is cast against a surface of a chill roll 76 under a combination of negative pressure from a vacuum box 78 and positive pressure from an air blanket 80 to form a quenched film 82. The quenched film 82 is stretched by CD IMG stretching at a CD IMG stretching station 84. The CD IMG-stretched film exiting CD IMG stretching station 84 receives subsequent post-stretching from a series of rollers moving at different speeds (e.g., machine direction stretching) at a post-stretching station 86. Once the film has undergone CD IMG stretching and subsequent post-stretching, the film is annealed at an annealing station 88, thus providing a patterned gas-permeable barrier film 2 in accordance with the present disclosure.

In illustrative embodiments, as shown in FIG. 10, the stretching process includes CD IMG stretching followed by post-stretching. The seersucker pattern formed during CD IMG stretching is maintained even after post-stretching since the orientation imparted by post-stretching is not sufficient to lighten the dark lanes. However, post-stretching is optional and is not required for the formation of a seersucker pattern in the stretched film (although it may be useful for imparting desired physical properties to the stretched film). For embodiments in which post-stretching in a machine direction is performed, the CD IMG-stretched film may be oriented such that the alternating vertical stripes are configured for elongation rather than widening.

The thermoplastic polymer 4 (or combination of thermoplastic polymers 4) used to make a patterned microporous breathable film 2 in accordance with the present disclosure is not restricted, and may include all manner of thermoplastic polymers capable of being stretched and of forming micropores. In illustrative embodiments, the thermoplastic polymer is a polyolefin, including but not limited to homopolymers, copolymers, terpolymers, and/or blends thereof.

Representative polyolefins that may be used in accordance with the present disclosure include but are not limited to low density polyethylene (LDPE), high density polyethylene (HDPE), linear low density polyethylene (LLDPE), ultra-low density polyethylene (ULDPE), polypropylene, ethylene-propylene copolymers, polymers made using a single-site catalyst, ethylene maleic anhydride copolymers (EMAs), ethylene vinyl acetate copolymers (EVAs), polymers made using Zeigler-Natta catalysts, styrene-containing block copolymers, and/or the like, and combinations thereof. Methods for manufacturing LDPE are described in The Wiley Encyclopedia of Packaging Technology, pp. 753-754 (Aaron L. Brody et al. eds., 2nd Ed. 1997) and in U.S. Pat. No. 5,399,426, both of which are incorporated by reference herein, except that in the event of any inconsistent disclosure or definition from the present specification, the disclosure or definition herein shall be deemed to prevail.

ULDPE may be produced by a variety of processes, including but not limited to gas phase, solution and slurry polymerization as described in The Wiley Encyclopedia of Packaging Technology, pp. 748-50 (Aaron L. Brody et al. eds., 2nd Ed. 1997), incorporated by reference above, except that in the event of any inconsistent disclosure or definition from the present specification, the disclosure or definition herein shall be deemed to prevail.

ULDPE may be manufactured using a Ziegler-Natta catalyst, although a number of other catalysts may also be used. For example, ULDPE may be manufactured with a metallocene catalyst. Alternatively, ULDPE may be manufactured with a catalyst that is a hybrid of a metallocene catalyst and a Ziegler-Natta catalyst. Methods for manufacturing ULDPE are also described in U.S. Pat. No. 5,399,426, U.S. Pat. No. 4,668,752, U.S. Pat. No. 3,058,963, U.S. Pat. No. 2,905,645, U.S. Pat. No. 2,862,917, and U.S. Pat. No. 2,699,457, each of which is incorporated by reference herein in its entirety, except that in the event of any inconsistent disclosure or definition from the present specification, the disclosure or definition herein shall be deemed to prevail. The density of ULDPE is achieved by copolymerizing ethylene with a sufficient amount of one or more monomers. In illustrative embodiments, the monomers are selected from 1-butene, 1-hexene, 4-methyl-1-pentene, 1-octene, and combinations thereof. Methods for manufacturing polypropylene are described in Kirk-Othmer Concise Encyclopedia of Chemical Technology, pp. 1420-1421 (Jacqueline I. Kroschwitz et al. eds., 4th Ed. 1999), which is incorporated herein by reference, except that in the event of any inconsistent disclosure or definition from the present specification, the disclosure or definition herein shall be deemed to prevail.

In illustrative embodiments, a polyolefin for use in accordance with the present disclosure includes polyethylene, polypropylene, or a combination thereof. In one example, the polyethylene includes linear low density polyethylene which, in some embodiments, includes a metallocene polyethylene. In another example, the polyethylene includes a combination of linear low density polyethylene and low density polyethylene. In a further example, the polyolefin consists essentially of only linear low density polyethylene.

In addition to thermoplastic polymer (e.g., polyolefin), a composition to be extruded in accordance with the present disclosure further includes a solid filler. The solid filler is not restricted, and may include all manner of inorganic or organic materials that are (a) non-reactive with thermoplastic polymer, (b) configured for being uniformly blended and dispersed in the thermoplastic polymer, and (c) configured to promote a microporous structure within the film when the film is stretched. In illustrative embodiments, the solid filler includes an inorganic filler.

Representative inorganic fillers for use in accordance with the present disclosure include but are not limited to sodium carbonate, calcium carbonate, magnesium carbonate, barium sulfate, magnesium sulfate, aluminum sulfate, magnesium oxide, calcium oxide, alumina, mica, talc, silica, clay (e.g., non-swellable clay), glass spheres, titanium dioxide, aluminum hydroxide, zeolites, and a combination thereof. In illustrative embodiments, the inorganic filler includes an alkali metal carbonate, an alkaline earth metal carbonate, an alkali metal sulfate, an alkaline earth metal sulfate, or a combination thereof. In one example, the inorganic filler includes calcium carbonate.

In another example, the solid filler includes a polymer (e.g., high molecular weight high density polyethylene, polystyrene, nylon, blends thereof, and/or the like). The use of polymer fillers creates domains within the thermoplastic polymer matrix. These domains are small areas, which may be spherical, where only the polymer filler is present as compared to the remainder of the thermoplastic matrix where no polymer filler is present. As such, these domains act as particles.

The solid filler 6 provided in a composition to be extruded in accordance with the present disclosure may be used to produce micropores 8 of film 2, as shown in FIG. 1. The dimensions of the solid filler 6 particles may be varied based on a desired end use (e.g., the desired properties of the patterned microporous breathable film 2). In one example, the average particle size of a solid filler particle ranges from about 0.1 microns to about 15 microns. In illustrative embodiments, the average particle size ranges from about 1 micron to about 5 microns and, in some examples, from about 1 micron to about 3 microns. The average particle size may be one of several different values or fall within one of several different ranges. For example, it is within the scope of the present disclosure to select an average particle size of the solid filler to be one of the following values: about 0.1 microns, 0.2 microns, 0.3 microns, 0.4 microns, 0.5 microns, 0.6 microns, 0.7 microns, 0.8 microns, 0.9 microns, 1.0 microns, 1.1 microns, 1.2 microns, 1.3 microns, 1.4 microns, 1.5 microns, 1.6 microns, 1.7 microns, 1.8 microns, 1.9 microns, 2.0 microns, 2.1 microns, 2.2 microns, 2.3 microns, 2.4 microns, 2.5 microns, 2.6 microns, 2.7 microns, 2.8 microns, 2.9 microns, 3.0 microns, 3.5 microns, 4.0 microns, 4.5 microns, 5.0 microns, 5.5 microns, 6.0 microns, 6.5 microns, 7.0 microns, 7.5 microns, 8.0 microns, 8.5 microns, 9.0 microns, 9.5 microns. 10.0 microns, 10.5 microns, 11.0 microns, 11.5 microns, 12.0 microns, 12.5 microns, 13.0 microns, 13.5 microns, 14.0 microns, 14.5 microns, or 15.0 microns.

It is also within the scope of the present disclosure for the average particle size of the solid filler 6 provided in a composition to be extruded in accordance with the present disclosure to fall within one of many different ranges. In a first set of ranges, the average particle size of the solid filler 6 is in one of the following ranges: about 0.1 microns to 15 microns, 0.1 microns to 14 microns, 0.1 microns to 13 microns, 0.1 microns to 12 microns, 0.1 microns to 11 microns, 0.1 microns to 10 microns, 0.1 microns to 9 microns, 0.1 microns to 8 microns, 0.1 microns to 7 microns, 0.1 microns to 6 microns, 0.1 microns to 5 microns, 0.1 microns to 4 microns, and 0.1 microns to 3 microns. In a second set of ranges, the average particle size of the solid filler 6 is in one of the following ranges: about 0.1 microns to 5 microns, 0.2 microns to 5 microns, 0.3 microns to 5 microns, 0.4 microns to 5 microns, 0.5 microns to 5 microns, 0.6 microns to 5 microns, 0.7 microns to 5 microns, 0.8 microns to 5 microns, 0.9 microns to 5 microns, and 1.0 microns to 5 microns. In a third set of ranges, the average particle size of the solid filler 6 is in one of the following ranges: about 0.1 microns to 4.9 microns, 0.2 microns to 4.8 microns, 0.3 microns to 4.7 microns, 0.4 microns to 4.6 microns, 0.5 microns to 4.5 microns, 0.6 microns to 4.4 microns, 0.7 microns to 4.3 microns, 0.8 microns to 4.2 microns, 0.9 microns to 4.1 microns, and 1.0 microns to 4.0 microns.

In illustrative embodiments, the amount of solid filler used in accordance with the present disclosure includes from about 30% by weight to about 75% by weight of the composition to be extruded, quenched film formed from the extruded composition, and/or patterned microporous breathable film formed from the quenched film. In further illustrative embodiments, the amount of solid filler used in accordance with the present disclosure includes from about 50% by weight to about 75% by weight of the composition to be extruded, quenched film formed from the extruded composition, and/or patterned microporous breathable film formed from the quenched film. Although amounts of filler outside this range may also be employed, an amount of solid filler that is less than about 30% by weight may not be sufficient to impart uniform breathability to a film. Conversely, amounts of filler greater than about 75% by weight may be difficult to blend with the polymer and may cause a loss in strength in the final patterned microporous breathable film.

The amount of solid filler 6 may be varied based on a desired end use (e.g., the desired properties of the patterned microporous breathable film 2). In one example, the amount of solid filler 6 ranges from about 40% to about 60% by weight of the composition, quenched film, and/or patterned microporous breathable film. In another example, the amount of solid filler 6 ranges from about 45% to about 55% by weight of the composition, quenched film, and/or patterned microporous breathable film. The amount of solid filler 6 may be one of several different values or fall within one of several different ranges. For example, it is within the scope of the present disclosure to select an amount of the solid filler 6 to be one of the following values: about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, or 75% by weight of the composition, quenched film, and/or patterned microporous breathable film.

It is also within the scope of the present disclosure for the amount of the solid filler 6 to fall within one of many different ranges. In a first set of ranges, the amount of the solid filler 6 is in one of the following ranges: about 31% to 75%, 32% to 75%, 33% to 75%, 34% to 75%, 35% to 75%, 36% to 75%, 37% to 75%, 38% to 75%, 39% to 75%, 40% to 75%, 41% to 75%, 42% to 75%, 43% to 75%, 44% to 75%, and 45% to 75% by weight of the composition, quenched film, and/or patterned microporous breathable film. In a second set of ranges, the amount of the solid filler is in one of the following ranges: about 30% to 74%, 30% to 73%, 30% to 72%, 30% to 71%, 30% to 70%, 30% to 69%, 30% to 68%, 30% to 67%, 30% to 66%, 30% to 65%, 30% to 64%, 30% to 63%, 30% to 62%, 30% to 61%, 30% to 60%, 30% to 59%, 30% to 58%, 30% to 57%, 30% to 56%, 30% to 55%, 30% to 54%, 30% to 53%, 30% to 52%, 30% to 51%, 30% to 50%, 30% to 49%, 30% to 48%, 30% to 47%, 30% to 46%, and 30% to 45% by weight of the composition, quenched film, and/or patterned microporous breathable film. In a third set of ranges, the amount of the solid filler is in one of the following ranges: about 31% to 74%, 32% to 73%, 33% to 72%, 34% to 71%, 35% to 70%, 36% to 69%, 37% to 68%, 38% to 67%, 39% to 66%, 40% to 65%, 41% to 64%, 42% to 63%, 43% to 62%, 44% to 61%, 45% to 60%, 45% to 59%, 45% to 58%, 45% to 57%, 45% to 56%, and 45% to 55% by weight of the composition, quenched film, and/or patterned microporous breathable film.

Although filler loading may be conveniently expressed in terms of weight percentages, the phenomenon of microporosity may alternatively be described in terms of volume percent of filler relative to total volume. By way of illustration, for calcium carbonate filler having a specific gravity of 2.7 g/cc and a polymer having a specific gravity of about 0.9, 35% by weight CaCO₃ corresponds to a filler loading of about 15% by volume {(0.35/2.7)/(0.65/0.9+0.35/2.7)}. Similarly, the 75 weight percent upper end of the range described above corresponds to about 56% by volume of CaCO₃. Thus, the amount of filler may be adjusted to provide comparable volume percentages for alternative solid fillers that have different (e.g., unusually low or high) specific gravities as compared to calcium carbonate.

In some embodiments, to render the solid filler particles free-flowing and to facilitate their dispersion in the polymeric material, the filler particles may be coated with a fatty acid and/or other suitable processing acid. Representative fatty acids for use in this context include but are not limited to stearic acid or longer chain fatty acids.

The type of stretching used to transform a quenched film into a patterned microporous breathable film 2 in accordance with the present disclosure is not restricted. All manner of stretching processes—and combinations of stretching processes—that are capable of moving (e.g., pulling) polymeric material 4 away from the surface of solid filler 6 dispersed therein in order to form micropores 8—are contemplated for use. In some examples, the stretching includes MD stretching. In other examples, the stretching includes CD IMG stretching. In further examples, the stretching includes MD IMG stretching. In still further examples, the stretching includes cold draw. In some embodiments, the stretching includes a combination of two or more different types of stretching including but not limited to MD stretching, CD IMG stretching, MD IMG stretching, cold draw, and/or the like. In some examples, the stretching includes a combination of CD IMG stretching and cold draw (which, in some embodiments, is performed subsequently to the CD IMG stretching).

In illustrative embodiments, the type of stretching used to transform a quenched film into a patterned microporous breathable film 2 in accordance with the present disclosure includes CD IMG stretching. In addition, in illustrative embodiments, at least a portion of the stretching is performed at a temperature above ambient temperature. In one example, at least a portion of the stretching is performed at a temperature of between about 60 degrees Fahrenheit and about 225 degrees Fahrenheit.

In illustrative embodiments, a process for making a patterned microporous breathable film 2 in accordance with the present disclosure further includes (d) annealing the patterned microporous breathable film 2. In one example, the annealing is performed at a temperature of between about 75 degrees Fahrenheit and about 225 degrees Fahrenheit.

In illustrative embodiments, as noted above, a patterned microporous breathable film 2 prepared in accordance with the present disclosure (e.g., by using a vacuum box and/or air knife to cast a molten web containing a polyolefin and an inorganic filler against a chill roll) may have reduced basis weight, increased Dart Impact Strength, and/or increased strain at peak machine direction as compared to conventional patterned microporous breathable films.

The basis weight of a patterned microporous breathable film 2 in accordance with the present disclosure may be varied based on a desired end use (e.g., the desired properties and/or applications of the patterned microporous breathable film). In one example, the basis weight ranges from about 5 gsm to about 30 gsm. In another example, the basis weight ranges from about 6 gsm to about 25 gsm. In illustrative embodiments, the basis weight is less than about 16 gsm, in some examples less than about 14 gsm, and, in other examples less than about 12 gsm. Although basis weights outside this range may also be employed (e.g., basis weights above about 30 gsm), lower basis weights minimize material cost as well as maximize consumer satisfaction (e.g., a thinner film may provide increased comfort to the user of a personal hygiene product that includes the film). The basis weight of a patterned microporous breathable film 2 in accordance with the present disclosure may be one of several different values or fall within one of several different ranges. For example, it is within the scope of the present disclosure to select a basis weight to be one of the following values: about 30 gsm, 29 gsm, 28 gsm, 27 gsm, 26 gsm, 25 gsm, 24 gsm, 23 gsm, 22 gsm, 21 gsm, 20 gsm, 19 gsm, 18 gsm, 17 gsm, 16 gsm, 15 gsm, 14 gsm, 13 gsm, 12 gsm, 11 gsm, 10 gsm, 9 gsm, 8 gsm, 7 gsm, 6 gsm, or 5 gsm.

It is also within the scope of the present disclosure for the basis weight of the patterned microporous breathable film 2 to fall within one of many different ranges. In a first set of ranges, the basis weight of the patterned microporous breathable film 2 is in one of the following ranges: about 5 gsm to 30 gsm, 6 gsm to 30 gsm, 7 gsm to 30 gsm, 8 gsm to 30 gsm, 9 gsm to 30 gsm, 10 gsm to 30 gsm, 11 gsm to 30 gsm, 12 gsm to 30 gsm, 13 gsm to 30 gsm, and 14 gsm to 30 gsm. In a second set of ranges, the basis weight of the patterned microporous breathable film is in one of the following ranges: about 5 gsm to 29 gsm, 5 gsm to 28 gsm, 5 gsm to 27 gsm, 5 gsm to 26 gsm, 5 gsm to 25 gsm, 5 gsm to 24 gsm, 5 gsm to 23 gsm, 5 gsm to 22 gsm, 5 gsm to 21 gsm, 5 gsm to 20 gsm, 5 gsm to 19 gsm, 5 gsm to 18 gsm, 5 gsm to 17 gsm, 5 gsm to 16 gsm, 5 gsm to 15 gsm, 5 gsm to 14 gsm, 5 gsm to 13 gsm, 5 gsm to 12 gsm, 5 gsm to 11 gsm, 5 gsm to 10 gsm, 5 gsm to 9 gsm, 5 gsm to 8 gsm, and 5 gsm to 7 gsm. In a third set of ranges, the basis weight of the patterned microporous breathable film 2 is in one of the following ranges: about 6 gsm to 29 gsm, 7 gsm to 29 gsm, 7 gsm to 28 gsm, 7 gsm to 27 gsm, 7 gsm to 26 gsm, 7 gsm to 25 gsm, 7 gsm to 24 gsm, 7 gsm to 23 gsm, 7 gsm to 22 gsm, 7 gsm to 21 gsm, 7 gsm to 20 gsm, 7 gsm to 19 gsm, 7 gsm to 18 gsm, 7 gsm to 17 gsm, 7 gsm to 16 gsm, 7 gsm to 15 gsm, 7 gsm to 14 gsm, and 7 gsm to 13 gsm.

In illustrative embodiments, a patterned microporous breathable film 2 in accordance with the present disclosure exhibits a greater Dart Impact Strength than conventional patterned microporous breathable films of similar basis weight. The basis weight of a patterned microporous breathable film 2 in accordance with the present disclosure may be varied based on a desired Dart Impact Strength. In one example, a patterned microporous breathable film 2 in accordance with the present disclosure has a basis weight of less than about 16 gsm—for example, less than about 14 gsm—and a Dart Impact Strength of at least about 50 grams. In another example, a patterned microporous breathable film 2 in accordance with the present disclosure has a basis weight of less than about 16 gsm—for example, less than about 14 gsm—and a Dart Impact Strength of at least about 75 grams. In a further example, a patterned microporous breathable film 2 in accordance with the present disclosure has a basis weight of less than about 16 gsm—for example, less than about 14 gsm—and a Dart Impact Strength of at least about 90 grams.

The Dart Impact Strength of a patterned microporous breathable film 2 in accordance with the present disclosure may be one of several different values or fall within one of several different ranges. For example, for a patterned microporous breathable film 2 having a basis weight of less than about 16 gsm—in some embodiments, less than about 15 gsm, 14 gsm, 13 gsm, 12 gsm, 11 gsm, 10 gsm, 9 gsm, or 8 gsm—it is within the scope of the present disclosure to select a Dart Impact Strength to be greater than or equal to one of the following values: about 50 grams, 51 grams, 52 grams, 53 grams, 54 grams, 55 grams, 56 grams, 57 grams, 58 grams, 59 grams, 60 grams, 61 grams, 62 grams, 63 grams, 64 grams, 65 grams, 66 grams, 67 grams, 68 grams, 69 grams, 70 grams, 71 grams, 72 grams, 73 grams, 74 grams, 75 grams, 76 grams, 77 grams, 78 grams, 79 grams, 80 grams, 81 grams, 82 grams, 83 grams, 84 grams, 85 grams, 86 grams, 87 grams, 88 grams, 89 grams, 90 grams, 91 grams, 92 grams, 93 grams, 94 grams, 95 grams, 96 grams, 97 grams, 98 grams, 99 grams, 100 grams, 101 grams, 102 grams, 103 grams, 104 grams, 105 grams, 106 grams, 107 grams, 108 grams, 109 grams, 110 grams, 111 grams, 112 grams, 113 grams, 114 grams, 115 grams, 116 grams, 117 grams, 118 grams, 119 grams, 120 grams, 121 grams, 122 grams, 123 grams, 124 grams, 125 grams, 126 grams, 127 grams, 128 grams, 129 grams, 130 grams, 131 grams, 132 grams, 133 grams, 134 grams, 135 grams, 136 grams, 137 grams, 138 grams, 139 grams, 140 grams, 141 grams, 142 grams, 143 grams, 144 grams, 145 grams, 146 grams, 147 grams, 148 grams, 149 grams, 150 grams, 151 grams, 152 grams, 153 grams, 154 grams, 155 grams, 156 grams, 157 grams, 158 grams, 159 grams, 160 grams, 161 grams, 162 grams, 163 grams, 164 grams, 165 grams, 166 grams, 167 grams, 168 grams, 169 grams, 170 grams, 171 grams, 172 grams, 173 grams, 174 grams, 175 grams, 176 grams, 177 grams, 178 grams, 179 grams, 180 grams, 181 grams, 182 grams, 183 grams, 184 grams, 185 grams, 186 grams, 187 grams, 188 grams, 189 grams, 190 grams, 191 grams, 192 grams, 193 grams, 194 grams, 195 grams, 196 grams, 197 grams, 198 grams, 199 grams, 200 grams, 201 grams, 202 grams, 203 grams, 204 grams, or 205 grams.

It is also within the scope of the present disclosure for the Dart Impact Strength of the patterned microporous breathable film 2 to fall within one of many different ranges. In a first set of ranges, the Dart Impact Strength for a patterned microporous breathable film having a basis weight of less than about 16 gsm—in some embodiments, less than about 15 gsm, 14 gsm, 13 gsm, 12 gsm, 11 gsm, 10 gsm, 9 gsm, or 8 gsm—is in one of the following ranges: about 50 grams to 250 grams, 55 grams to 250 grams, 60 grams to 250 grams, 65 grams to 250 grams, 70 grams to 250 grams, 75 grams to 250 grams, 80 grams to 250 grams, 85 grams to 250 grams, 90 grams to 250 grams, 95 grams to 250 grams, 100 grams to 250 grams, 105 grams to 250 grams, 110 grams to 250 grams, 115 grams to 250 grams, 120 grams to 250 grams, 125 grams to 250 grams, 130 grams to 250 grams, 135 grams to 250 grams, 140 grams to 250 grams, 145 grams to 250 grams, 150 grams to 250 grams, 155 grams to 250 grams, 160 grams to 250 grams, 165 grams to 250 grams, 170 grams to 250 grams, 175 grams to 250 grams, 180 grams to 250 grams, 185 grams to 250 grams, 190 grams to 250 grams, 195 grams to 250 grams, 200 grams to 250 grams, and 205 grams to 250 grams. In a second set of ranges, the Dart Impact Strength for a patterned microporous breathable film 2 having a basis weight of less than about 16 gsm—in some embodiments, less than about 15 gsm, 14 gsm, 13 gsm, 12 gsm, 11 gsm, 10 gsm, 9 gsm, or 8 gsm—is in one of the following ranges: about 50 grams to 249 grams, 50 grams to 245 grams, 50 grams to 240 grams, 50 grams to 235 grams, 50 grams to 230 grams, 50 grams to 225 grams, 50 grams to 220 grams, 50 grams to 215 grams, and 50 grams to 210 grams. In a third set of ranges, the Dart Impact Strength for a patterned microporous breathable film 2 having a basis weight of less than about 16 gsm—in some embodiments, less than about 15 gsm, 14 gsm, 13 gsm, 12 gsm, 11 gsm, 10 gsm, 9 gsm, or 8 gsm—is in one of the following ranges: about 51 grams to about 249 grams, 55 grams to 245 grams, 60 grams to 240 grams, 65 grams to 235 grams, 70 grams to 230 grams, 75 grams to 225 grams, 80 grams to 225 grams, 85 grams to 225 grams, 90 grams to 225 grams, 95 grams to 225 grams, 100 grams to 225 grams, 105 grams to 225 grams, 110 grams to 225 grams, 115 grams to 225 grams, 120 grams to 225 grams, 125 grams to 225 grams, 130 grams to 225 grams, 135 grams to 225 grams, 140 grams to 225 grams, 145 grams to 225 grams, 150 grams to 225 grams, 155 grams to 225 grams, 160 grams to 225 grams, 165 grams to 225 grams, 170 grams to 225 grams, 175 grams to 225 grams, 180 grams to 225 grams.

In illustrative embodiments, a patterned microporous breathable film 2 in accordance with the present disclosure exhibits a greater strain at peak machine direction than conventional patterned microporous breathable films of similar basis weight. The basis weight of a patterned microporous breathable film 2 in accordance with the present disclosure may be varied based on a desired strain at peak machine direction. In one example, a patterned microporous breathable film 2 in accordance with the present disclosure has a basis weight of less than about 16 gsm—for example, less than about 14 gsm—and a strain at peak machine direction of at least about 75%. In another example, a patterned microporous breathable film 2 in accordance with the present disclosure has a basis weight of less than about 16 gsm—for example, less than about 14 gsm—and a strain at peak machine direction of at least about 100%. In a further example, a patterned microporous breathable film 2 in accordance with the present disclosure has a basis weight less than about 16 gsm—for example, less than about 14 gsm—and a strain at peak machine direction of at least about 125%.

The strain at peak machine direction of a patterned microporous breathable film 2 in accordance with the present disclosure may be one of several different values or fall within one of several different ranges. For example, for a patterned microporous breathable film having a basis weight of less than about 16 gsm—in some embodiments, less than about 15 gsm, 14 gsm, 13 gsm, 12 gsm, 11 gsm, 10 gsm, 9 gsm, or 8 gsm—it is within the scope of the present disclosure to select a strain at peak machine direction to be greater than or equal to one of the following values: about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 100%, 101%, 102%, 103%, 104%, 105%, 106%, 107%, 108%, 109%, 110%, 111%, 112%, 113%, 114%, 115%, 116%, 117%, 118%, 119%, 120%, 121%, 122%, 123%, 124%, 125%, 126%, 127%, 128%, 129%, 130%, 131%, 132%, 133%, 134%, 135%, 136%, 137%, 138%, 139%, 140%, 141%, 142%, 143%, 144%, 145%, 146%, 147%, 148%, 149%, 150%, 151%, 152%, 153%, 154%, 155%, 156%, 157%, 158%, 159%, 160%, 161%, 162%, 163%, 164%, 165%, 166%, 167%, 168%, 169%, 170%, 171%, 172%, 173%, 174%, 175%, 176%, 177%, 178%, 179%, 180%, 181%, 182%, 183%, 184%, 185%, 186%, 187%, 188%, 189%, 190%, 191%, 192%, 193%, 194%, 195%, 196%, 197%, 198%, 199%, 200%, 201%, 202%, 203%, 204%, 205%, 206%, 207%, 208%, 209%, 210%, 211%, 212%, 213%, 214%, 215%, 216%, 217%, 218%, 219%, 220%, 221%, 222%, 223%, 224%, 225%, 226%, 227%, 228%, 229%, 230%, 231%, 232%, 233%, 234%, 235%, 236%, 237%, 238%, 239%, 240%, 241%, 242%, 243%, 244%, 245%, 246%, 247%, 248%, 249%, 250%, 251%, 252%, 253%, 254%, 255%, 256%, 257%, 258%, 259%, 260%, 261%, 262%, 263%, 264%, 265%, 266%, 267%, 268%, 269%, 270%, 271%, 272%, 273%, 274%, 275%, 276%, 277%, 278%, 279%, 280%, 281%, 282%, 283%, 284%, 285%, 286%, 287%, 288%, 289%, 290%, 291%, 292%, 293%, 294%, 295%, 296%, 297%, 298%, 299%, or 300%.

It is also within the scope of the present disclosure for the strain at peak machine direction of the patterned microporous breathable film 2 to fall within one of many different ranges. In a first set of ranges, the strain at peak machine direction for a patterned microporous breathable film having a basis weight of less than about 16 gsm—in some embodiments, less than about 15 gsm, 14 gsm, 13 gsm, 12 gsm, 11 gsm, 10 gsm, 9 gsm, or 8 gsm—is in one of the following ranges: about 75% to 350%, 75% to 345%, 75% to 340%, 75% to 335%, 75% to 330%, 75% to 325%, 75% to 320%, 75% to 315%, 75% to 310%, 75% to 305%, 75% to 300%, 75% to 295%, 75% to 290%, 75% to 285%, and 75% to 280%. In a second set of ranges, the strain at peak machine direction for a patterned microporous breathable film 2 having a basis weight of less than about 16 gsm—in some embodiments, less than about 15 gsm, 14 gsm, 13 gsm, 12 gsm, 11 gsm, 10 gsm, 9 gsm, or 8 gsm—is in one of the following ranges: about 76% to 350%, 77% to 350%, 78% to 350%, 79% to 350%, 80% to 350%, 81% to 350%, 82% to 350%, 83% to 350%, 84% to 350%, 85% to 350%, 86% to 350%, 87% to 350%, 88% to 350%, 89% to 350%, 90% to 350%, 91% to 350%, 92% to 350%, 93% to 350%, 94% to 350%, 95% to 350%, 96% to 350%, 97% to 350%, 98% to 350%, 99% to 350%, 100% to 350%, 101% to 350%, 102% to 350%, 103% to 350%, 104% to 350%, 105% to 350%, 106% to 350%, 107% to 350%, 108% to 350%, 109% to 350%, 110% to 350%, 111% to 350%, 112% to 350%, 113% to 350%, 114% to 350%, 115% to 350%, 116% to 350%, 117% to 350%, 118% to 350%, 119% to 350%, 120% to 350%, 121% to 350%, 122% to 350%, 123% to 350%, 124% to 350%, 125% to 350%, 126% to 350%, 127% to 350%, 128% to 350%, 129% to 350%, 130% to 350%, 131% to 350%, 132% to 350%, 133% to 350%, 134% to 350%, 135% to 350%, 136% to 350%, 137% to 350%, 138% to 350%, 139% to 350%, 140% to 350%, 141% to 350%, 142% to 350%, 143% to 350%, 144% to 350%, 145% to 350%, 146% to 350%, 147% to 350%, 148% to 350%, 149% to 350%, 150% to 350%, 151% to 350%, 152% to 350%, 153% to 350%, 154% to 350%, 155% to 350%, 156% to 350%, 157% to 350%, 158% to 350%, 159% to 350%, 160% to 350%, 161% to 350%, 162% to 350%, 163% to 350%, 164% to 350%, 165% to 350%, 166% to 350%, 167% to 350%, 168% to 350%, 169% to 350%, 170% to 350%, 171% to 350%, 172% to 350%, 173% to 350%, 174% to 350%, 175% to 350%, 176% to 350%, 177% to 350%, 178% to 350%, 179% to 350%, 180% to 350%, 181% to 350%, 182% to 350%, 183% to 350%, 184% to 350%, 185% to 350%, 186% to 350%, 187% to 350%, 188% to 350%, 189% to 350%, 190% to 350%, 191% to 350%, 192% to 350%, 193% to 350%, 194% to 350%, 195% to 350%, 196% to 350%, 197% to 350%, 198% to 350%, 199% to 350%, 200% to 350%, 201% to 350%, 202% to 350%, 203% to 350%, 204% to 350%, 205% to 350%, 206% to 350%, 207% to 350%, 208% to 350%, 209% to 350%, 210% to 350%, 211% to 350%, 212% to 350%, 213% to 350%, 214% to 350%, and 215% to 350%. In a third set of ranges, the strain at peak machine direction for a patterned microporous breathable film 2 having a basis weight of less than about 16 gsm—in some embodiments, less than about 15 gsm, 14 gsm, 13 gsm, 12 gsm, 11 gsm, 10 gsm, 9 gsm, or 8 gsm—is in one of the following ranges: about 75% to 349%, 80% to 345%, 85% to 340%, 90% to 335%, 95% to 330%, 100% to 325%, 105% to 320%, 110% to 315%, 115% to 310%, 120% to 305%, 125% to 300%, 130% to 300%, 135% to 300%, 140% to 300%, 145% to 300%, 150% to 300%, 155% to 300%, 160% to 300%, 165% to 300%, 170% to 300%, 175% to 300%, 180% to 300%, 185% to 300%, 190% to 300%, 195% to 300%, 200% to 300%, 205% to 300%, 210% to 300%, 215% to 300%, 220% to 300%, and 225% to 300%.

In some embodiments, as described above, the present disclosure provides a monolayer patterned microporous breathable film 2, as shown in FIG. 1. In other embodiments, the present disclosure also provides a multi-layer patterned microporous breathable film. In one example, a multilayer patterned microporous breathable film includes a core layer and one or more outer skin layers adjacent to the core layer. The one or more outer skin layers may have either the same composition as the core or a different composition than the core. In one example, the skin layers may be independently selected from compositions designed to minimize the levels of volatiles building up on the extrusion die. Upon subsequent stretching, the core layer becomes microporous and breathable, while the skin layers may or may not be breathable depending upon whether or not they contain a solid filler. The thickness and composition of one or more skin layers in a multilayer version of a patterned microporous breathable film are selected so that, when the precursor film is subsequently stretched, the resulting film is still breathable. In one example, a pair of skin layers sandwiching a core layer are relatively thin and together account for no more than about 30% of the total film thickness. In some embodiments, regardless of whether or not a skin layer contains a solid filler, the skin layer may still be breathable. For example, the skin layer may include one or more discontinuities that are introduced during the stretching process. The likelihood of discontinuities forming in a skin layer may increase as the thickness of the skin layer subjected to stretching decreases.

In some embodiments, as shown in FIG. 6, the core layer of the film resembles the film 2 shown in FIG. 1, and may include a thermoplastic polymer (or combination of thermoplastic polymers), a solid filler (or combination of solid fillers), and a pigment (or combination of pigments) dispersed therein. The two outer skin layers may include a thermoplastic polymer (or combination of thermoplastic polymers) and be substantially devoid of pigment and solid filler. In other embodiments, as shown in FIG. 7, the core layer of the film resembles the film 2 shown in FIG. 1, and may include a thermoplastic polymer (or combination of thermoplastic polymers) and a solid filler (or combination of solid fillers) dispersed therein. The core layer shown in FIG. 7 may be substantially free of pigment, whereas the two outer skin layers may include a thermoplastic polymer (or combination of thermoplastic polymers) and a pigment (or combination of pigments). Additional examples of a multi-layer patterned microporous breathable film in accordance with the present disclosure are described below in reference to FIG. 11.

In one example, a multi-layer patterned microporous breathable films in accordance with the present disclosure may be manufactured by feed block coextrusion. In another example, a multi-layer patterned microporous breathable films in accordance with the present disclosure may be made by blown film (tubular) coextrusion. Methods for feed block and blown film extrusion are described in The Wiley Encyclopedia of Packaging Technology, pp. 233-238 (Aaron L. Brody et al. eds., 2nd Ed. 1997), which is incorporated herein by reference, except that in the event of any inconsistent disclosure or definition from the present specification, the disclosure or definition herein shall be deemed to prevail. Methods for film extrusion are also described in U.S. Pat. No. 6,265,055, the entire contents of which are likewise incorporated by reference herein, except that in the event of any inconsistent disclosure or definition from the present specification, the disclosure or definition herein shall be deemed to prevail.

In some embodiments, as described above, the present disclosure provides patterned microporous breathable films (e.g., mono-layer or multi-layer). In other embodiments, the present disclosure further provides patterned multi-layer breathable barrier films.

A patterned multi-layer breathable barrier film 56 is shown, for example, in FIG. 11. The patterned multi-layer breathable barrier film 56 shown in FIG. 11 includes at least one patterned microporous breathable film layer 58 and at least one monolithic moisture-permeable barrier layer 60. The monolithic moisture-permeable barrier layer 60 includes a hygroscopic polymer. In illustrative embodiments, the monolithic moisture-permeable barrier layer 60 is a monolithic hydrophilic polymer. Monolithic hydrophilic polymers are able to transmit moisture without the additional need of fillers and stretching. The mechanism of breathability in a monolithic hydrophilic polymer is accomplished by absorption and desorption of moisture.

The at least one patterned microporous breathable film layer 58 in FIG. 11 is analogous to the patterned microporous breathable film 2 shown in FIG. 1, and may be prepared by a process analogous to that described above. In one embodiment, the at least one patterned microporous breathable film layer 58 includes a polyolefin, an inorganic filler, and a pigment dispersed in the polyolefin. In other words, the pigment may be provided in the layer in which the micropores are formed. In another example, the pigment may also (or alternatively) be provided in a skin layer adjacent to the at least one patterned microporous breathable film layer 58. In illustrative embodiments, the at least one patterned microporous breathable film layer 58 has a basis weight of less than about 14 gsm and a Dart Impact Strength of greater than about 50 grams.

In illustrative embodiments, as shown in FIG. 11, the patterned multi-layer breathable barrier film 56 further includes at least at least one additional patterned microporous breathable film layer 62. The second patterned microporous breathable film layer 62 may be the same as or different than the first patterned microporous breathable film layer 58. For example, the first patterned microporous breathable film layer 58 and the second patterned microporous breathable film layer 62 may differ from each other in thickness, breathability, pore size, and/or thermoplastic composition.

The at least one additional patterned microporous breathable film layer 62—similar to the at least one patterned microporous breathable film layer 58—is analogous to the patterned microporous breathable film 2 shown in FIG. 1, and may be prepared by a process analogous to that described above. In one example, the at least one additional patterned microporous breathable film layer 62 includes a polyolefin, an inorganic filler, and a pigment dispersed in the polyolefin. In another example, the pigment may also (or alternatively) be provided in a skin layer adjacent to the microporous breathable film layer 62. In illustrative embodiments, the at least one additional patterned microporous breathable film layer 62 has a basis weight of less than about 14 gsm and a Dart Impact Strength of greater than about 50 grams. In illustrative embodiments, as shown in FIG. 11, the at least one monolithic moisture-permeable barrier layer 60 is disposed between the at least one patterned microporous breathable film layer 58 and the at least one additional patterned microporous breathable film layer 62 although other configurations may likewise be implemented.

The monolithic moisture-permeable barrier layer 60 shown in FIG. 11 provides an internal viral and alcohol barrier layer and—unlike patterned microporous breathable film layer 58 and patterned microporous breathable film layer 62—may be unfilled or substantially unfilled (e.g., contain an amount of solid filler that does not result in the creation of micropores as a result of stretching). In illustrative embodiments, the monolithic moisture-permeable barrier layer 60 contains a hygroscopic polymer including but not limited to the hygroscopic polymers described in International Patent Publication No. WO 2011/019504 A1. The entire contents of International Patent Publication No. WO 2011/019504 A1 are hereby incorporated by reference, except that in the event of any inconsistent disclosure or definition from the present specification, the disclosure or definition herein shall be deemed to prevail.

The monolithic moisture-permeable barrier layer 60 provides a barrier to viruses and to alcohol penetration. In one example, a tie layer (not shown) may be used to combine dissimilar layers (e.g., monolithic moisture-permeable barrier layer 60 and one or both of patterned microporous breathable film layer 58 and patterned microporous breathable film layer 62). In another example, an adhesive may be blended in one or more of the adjacent dissimilar layers, thus avoiding potential loss in permeability arising from a continuous non-breathable tie layer.

The internal monolithic moisture-permeable barrier layer 60 may include a hygroscopic polymer. In illustrative embodiments, the hygroscopic polymer is selected from the group consisting of hygroscopic elastomers, polyesters, polyamides, polyetherester copolymers, polyetheramide copolymers, polyurethanes, polyurethane copolymers, poly(etherimide) ester copolymers, polyvinyl alcohols, ionomers, celluloses, nitrocelluloses, and/or the like, and combinations thereof. In some embodiments, the at least one monolithic moisture-permeable barrier layer 60 further includes an adhesive which, in some embodiments, includes polyethylene/acrylate copolymer, ethylene/methyl acrylate copolymer, acid-modified acrylate, anhydride-modified acrylate, ethylene vinyl acetate, acid/acrylate-modified ethylene vinyl acetate, anhydride-modified ethylene vinyl acetate, and/or the like, or a combination thereof. The monolithic moisture-permeable barrier layer 60 may be prepared from a hygroscopic polymer resin or from a combination of hygroscopic polymer resins and, optionally, from a blend of one or more hygroscopic polymer resins and one or more adhesives.

In one example, the internal monolithic moisture-permeable barrier layer 60 may constitute from about 0.5% to about 30% of the total thickness of the film 56. In another example, the barrier layer 60 may constitute from about 1% to about 20% of the total thickness of the film 56. In a further example, the barrier layer 60 may constitute from about 2% to about 10% of the total thickness of the film 56. In some embodiments (not shown), the film 56 includes a plurality of monolithic moisture-permeable barrier layers 60, and the above-described exemplary ranges of thickness percentages may be applied to the sum of the multiple barrier layers within the film. Patterned multi-layer breathable barrier films 56 in accordance with the present disclosure may include one or more internal monolithic moisture-permeable barrier layers 60, which may be contiguous with each other or with interposed microporous breathable layers such as patterned microporous breathable layer 58 and patterned microporous breathable layer 62. In illustrative embodiments, one or more moisture-permeable barrier layers 60 provided in a patterned multi-layer breathable barrier film 56 in accordance with the present disclosure, are monolithic and do not contain any fillers that provide sites for the development of micropores. However, monolithic moisture-permeable barrier layers may contain other additives to confer desired properties to the barrier layer.

Representative materials for the monolithic moisture-permeable barrier layer 60 include but are not limited to hygroscopic polymers such as ε-caprolactone (available from Solvay Caprolactones), polyether block amides (available from Arkema PEBAX), polyester elastomer (such as Dupont Hytrel or DSM Arnitel) and other polyesters, polyamides, celluloses (e.g., cellulose fibers), nitrocelluloses (e.g., nitrocellulose fibers), ionomers (e.g., ethylene ionomers), and/or the like, and combinations thereof. In one example, fatty acid salt-modified ionomers as described in the article entitled “Development of New lonomers with Novel Gas Permeation Properties” (Journal of Plastic Film and Sheeting, 2007, 23, No. 2, 119-132) may be used as a monolithic moisture-permeable barrier layer 60. In some embodiments, sodium, magnesium, and/or potassium fatty acid salt-modified ionomers may be used to provide desirable water vapor transmission properties. In some embodiments, the monolithic moisture-permeable barrier layer 60 is selected from the group consisting of hygroscopic elastomers, polyesters, polyamides, polyetherester copolymers (e.g., a block polyetherester copolymer), polyetheramide copolymers (e.g., a block polyetheramide copolymer), polyurethanes, polyurethane copolymers, poly(etherimide) ester copolymers, polyvinyl alcohols, ionomers, celluloses, nitrocelluloses, and/or the like, and combinations thereof. In one example, copolyether ester block copolymers are segmented elastomers having soft polyether segments and hard polyester segments, as described in U.S. Pat. No. 4,739,012. Representative copolyether ester block copolymers are sold by DuPont under the trade name HYTREL®. Representative copolyether amide polymers are copolyamides sold under the trade name PEBAX® by Atochem Inc. of Glen Rock, N.J. Representative polyurethanes are thermoplastic urethanes sold under the trade name ESTANE® by the B. F. Goodrich Company of Cleveland, Ohio. Representative copoly(etherimide) esters are described in U.S. Pat. No. 4,868,062.

In some embodiments, the monolithic moisture-permeable barrier layer 60 may include or be blended with a thermoplastic resin. Representative thermoplastic resins that may be used for this purpose include but are not limited to polyolefins, polyesters, polyetheresters, polyamides, polyether amides, urethanes, and/or the like, and combinations thereof. In some embodiments, the thermoplastic polymer may include (a) a polyolefin, such as polyethylene, polypropylene, poly(i-butene), poly(2-butene), poly(i-pentene), poly(2-pentene), poly(3-methyl-1-pentene), poly(4-methyl-1-pentene), 1,2-poly-1,3-butadiene, 1,4-poly-1,3-butadiene, polyisoprene, polychloroprene, polyacrylonitrile, polyvinyl acetate, poly(vinylidene chloride), polystyrene, and/or the like, and combinations thereof; (b) a polyester such as poly(ethylene terephthalate), poly(butylenes)terephthalate, poly(tetramethylene terephthalate), poly(cyclohexylene-1,4-dimethylene terephthalate), poly(oxymethylene-1,4-cyclohexylenemethyleneoxyterephthaloyl), and/or the like, and combinations thereof; and (c) a polyetherester, such as poly(oxyethylene)-poly(butylene terephthalate), poly(oxytetramethylene)-poly(ethylene terephthalate), and/or the like, and combinations thereof; and/or (d) a polyamide, such as poly(6-aminocaproic acid), poly(caprolactam), poly(hexamethylene adipamide), poly(hexamethylene sebacamide), poly(11-aminoundecanoic acid), and/or the like, and combinations thereof.

In illustrative embodiments the hygroscopic polymer is a hygroscopic elastomer. A variety of additives may be added to the monolithic moisture-permeable barrier layer 60 to provide additional properties such as antimicrobial effects, odor control, static decay, and/or the like. One or more monolithic moisture-permeable barrier layers 60 is placed in the film 56 to impede the flow of liquids, liquid borne pathogens, viruses, and other microorganisms that may be carried by a liquid challenge.

One or more of the monolithic moisture-permeable barrier layers 60, the patterned microporous breathable film layer 58, and the patterned microporous breathable film layer 62 in the patterned multi-layer breathable barrier film 56 may include one or more adhesives for adhering the internal monolithic moisture-permeable barrier layer 60 to contiguous layers to form the multi-layer film 56. In one example, adhesive may be components suitable for adhering two or more layers together. In one example, adhesives are compatibilizing adhesives that increase the compatibility of the layers as well as adhering the layers to one another. The adhesives may be included in the resin or other extrudable material before extruding that resin into the monolithic moisture-permeable barrier layer 60. Representative compatibilizing adhesives include but are not limited to polyethylene/acrylate copolymer, ethylene/methyl acrylate copolymer, acid-modified acrylate, anhydride-modified acrylate, ethylene vinyl acetate, acid/acrylate-modified ethylene vinyl acetate, anhydride-modified ethylene vinyl acetate, and/or the like, and combinations thereof. In one example, when one of the microporous breathable layer 58, the microporous breathable layer 62, and the monolithic moisture-permeable barrier layer 60 includes an adhesive, the adhesive may have a relatively high methacrylate content (e.g., a methacrylate content of at least about 20% to 25%). In some embodiments, the internal monolithic moisture-permeable barrier layer 60 may be prepared from blends including up to about 50% by weight adhesive and at least about 50% by weight hygroscopic polymer.

In some embodiments, the hygroscopic polymer may be dried before it is extruded. Feeding pre-dried hygroscopic elastomer in small amounts to an extruder has proven to be effective in avoiding moisture absorption, preventing hydrolysis of the hygroscopic elastomer, and reducing or eliminating the formation of dark blue gels and holes in web. In some higher stretch ratio cases, gels rendered holes and even web break.

A patterned multi-layer breathable barrier film 56 in accordance with the present disclosure may contain one or a plurality of monolithic moisture-permeable barrier layers 60, each of which may be placed in any order in the inner layers of the film structure. In illustrative embodiments, the monolithic moisture-permeable barrier layer 60 is not placed on the outer surface of the resultant film 56 in order to avoid damage caused by foreign materials. In one example, when the film 56 contains a plurality of monolithic moisture-permeable barrier layers 60, individual monolithic moisture-permeable barrier layers 60 are not placed adjacent to each other inside the film in order to increase efficacy. When a plurality of monolithic moisture-permeable barrier layers 60 is used, the individual monolithic moisture-permeable barrier layers 60 may differ from each other in thickness and/or type of thermoplastic polymer.

In one example, a representative structure for a patterned multi-layer breathable barrier film 56 contains five layers (not shown), with one monolithic moisture-permeable barrier layer being in the core of the structure and four patterned microporous breathable film layers being arranged around the core. In one example, the five-layer breathable barrier film has a A-C-B-C-A structure, wherein A represents a first patterned microporous breathable film layer, C represents a second patterned microporous breathable film layer that is different than or the same as the first patterned microporous breathable film layer, and B represents a monolithic moisture-permeable barrier layer.

In one example, the outermost patterned microporous breathable film layer (A and/or C) contains Dow 5230G LLDPE or Dow PL1280 ULDPE or Dow 5630 LLDPE, calcium carbonate, and a pigment. Additional antioxidants, colorants, and/or processing aids may optionally be added. In another example, the pigment may also (or alternatively) be provided in a skin layer adjacent to the outermost patterned microporous breathable film layer (A and/or C). The patterned microporous breathable film layer A may differ from the patterned microporous breathable film layer C in the amount and/or identity of solid filler present (e.g., calcium carbonate, barium sulfate, talc, glass spheres, other inorganic particles, etc.) and/or in the presence, absence, or type of pigment present. The inner monolithic moisture-permeable barrier layer B may contain a hygroscopic elastomer such as Dupont HYTREL PET and an adhesive such as Dupont BYNEL 3101 20% EVA or Dupont AC1820 acrylate, with additional antioxidants, colorants, and processing aids optionally being added. In one example, the inner monolithic moisture-permeable barrier layer B contains about 50% adhesive and about 50% by weight or more of hygroscopic elastomer. Instead of a polyester elastomer, other hygroscopic polymers, such as ε-caprolactone, polyester block amides, polyester elastomers, polyamides, and blends thereof may be utilized as the inner monolithic moisture-permeable barrier layers.

Patterned multi-layer breathable barrier films 56 of a type described above are not limited to any specific kind of film structure. Other film structures may achieve the same or similar result as the three-layer film 56 shown in FIG. 11 or the five-layer structure A-C-B-C-A described above. Film structure is a function of equipment design and capability. For example, the number of layers in a film depends only on the technology available and the desired end use for the film. Representative examples of film structures that may be implemented in accordance with the present disclosure include but are not limited to the following, wherein A represents a patterned microporous breathable film layer (e.g., 58 or 62) and B represents an alcohol and viral monolithic moisture-permeable barrier layer (e.g., 60):

### A-B-A

### A-A-B-A

### A-B-A-A

### A-A-B-A-A

### A-B-A-A-A

### A-B-A-B-A

### A-B-A-A-A-A-A

### A-A-B-A-A-A-A

### A-A-A-B-A-A-A

### A-B-A-A-A-B-A

### A-B-A-A-B-A-A

### A-B-A-B-A-A-A

### A-B-A-B-A-B-A

### A-B-A-A-A-A-A-A

### A-A-B-A-A-A-A-A

### A-A-A-B-A-A-A-A

### A-B-A-A-A-A-B-A.

In the above-described exemplary film structures, each of the patterned microporous breathable film layers A may include two or more patterned microporous breathable film layers in order to better control other film properties, such as the ability to bond to nonwovens. For example, when there are two patterned microporous breathable film layers in one A patterned microporous breathable film layer, and when C represents the second patterned microporous breathable film layer, some exemplary film structures are as follows:

### A-C-B-C-A

### A-C-A-C-B-C-A

### A-C-B-C-A-C-A

### A-C-A-C-B-C-A-C-A

### A-C-B-C-A-C-A-C-A

### A-C-B-C-A-B-C-A

Additionally, die technology that allows production of multiple layers in a multiplier fashion may be used. For example, an ABA structure may be multiplied from about 10 to about 1000 times. The resulting 10-time multiplied ABA structure may be expressed as follows:

### A-B-A-A-B-A-A-B-A-A-B-A-A-B-A-A-B-A-A-B-A-A-B-A-A-B-A-A-B-A

Representative applications using a patterned microporous breathable film 2 and/or a patterned multi-layer breathable barrier film 56 include but are not limited to medical gowns, diaper back sheets, drapes, packaging, garments, articles, carpet backing, upholstery backing, bandages, protective apparel, feminine hygiene, building construction, bedding and/or the like. Films in accordance with the present disclosure may be laminated to a fabric, scrim, or other film support by thermal, ultrasonic, and/or adhesive bonding. The support may be attached to at least one face of the film and or to both faces of the film. The laminate may be made using wovens, knits, nonwovens, paper, netting, or other films. Adhesive bonding may be used to prepare such laminates. Adhesive bonding may be performed with adhesive agents such as powders, adhesive webs, liquid, hot-melt and solvent-based adhesives. Additionally, these types of support may be used with ultrasonic or thermal bonding if the polymers in the support are compatible with the film surface. Laminates of the present multilayer films and nonwoven fabrics may provide surgical barriers. In one example, the fabrics are spunbonded or spunbond-meltblown-spunbond (SMS) fabrics. In another example, the fabrics may be spunlaced, airlaid, powder-bonded, thermal-bonded, or resin-bonded. The encasing of the monolithic moisture-permeable barrier layer 60 protects the monolithic moisture-permeable barrier layer 60 from mechanical damage or thermal damage and allows for thermal and ultrasonic bonding of the multilayer film at extremely low thicknesses.

In some embodiments, the formation of a pattern in accordance with the present disclosure may also be applied to non-breathable or partially breathable films (e.g., multi-layer films that contain at least one cavitated breathable layer and at least one non-cavitated, non-breathable, polyolefin-containing additional layer formed, for example, via co-extrusion).

In some embodiments, heat (e.g., glue or sealing) may be applied to a patterned microporous breathable film 2 and/or a patterned multi-layer breathable barrier film 56 in accordance with the present disclosure in order to change (e.g., intensify) coloration of a pattern. For example, application of heat at one or more cavitation sites may be used to reduce the degree of cavitation at the one or more sites (e.g., reduce the whitening effect), thereby intensifying the color.

Patterned microporous breathable films 2 (e.g., monolayer and/or multi-layer) and/or patterned multi-layer breathable barrier films 56 in accordance with the present disclosure may be used in applications in the medical field. Porous webs are used currently in the medical field for ethylene oxide (EtO) sterilization as the gas must be able to permeate packaging in order to sterilize the contents. These porous webs are often used as the top sheets for rigid trays and as breather films in pouches. Medical paper is commonly used for these purposes as is flashspun high-density polyethylene of the type sold under the trade name TYVEK by Dupont. The patterned multi-layer breathable barrier films 56 in accordance with the present disclosure may be used to replace either of these products in such applications.

In one example, patterned multi-layer breathable barrier films 56 in accordance with the present disclosure may be used in any application that involves a blood barrier. For example, disposable blankets, operating table covers, or surgical drapes may incorporate a patterned multilayer breathable barrier film 56 in accordance with the present disclosure, as they represent blood barrier applications that might function more comfortably with a breathable substrate.

In some embodiments, as described above, the present disclosure provides patterned microporous breathable films 2 (e.g., mono-layer or multi-layer) and patterned multi-layer breathable barrier films 56. In other embodiments, the present disclosure further provides personal hygiene products containing one or more patterned microporous breathable films (e.g., mono-layer or multi-layer) in accordance with the present disclosure, and/or one or more patterned multi-layer breathable barrier films in accordance with the present disclosure. In illustrative embodiments, a personal hygiene product in accordance with the present disclosure includes at least one patterned microporous breathable film 2 prepared by a process as described above and at least one outer non-woven layer. The at least one patterned microporous breathable film 2 is configured for contacting skin and/or clothing of a user of the personal hygiene product. In some embodiments, the personal hygiene product further includes at least one monolithic moisture-permeable barrier layer 60 disposed between the at least one patterned microporous breathable film 2 and the at least one outer non-woven layer.

In one example, the at least one patterned microporous breathable film 2 is bonded to the at least one outer non-woven layer without an adhesive (e.g., via heat sealing, ultrasonic welding, and/or the like). In some embodiments, each of the at least one patterned microporous breathable film 2 and the at least one outer non-woven layer comprises polypropylene and/or polyethylene. In illustrative embodiments, the patterned microporous breathable film 2 includes calcium carbonate as the solid filler.

In illustrative embodiments, the personal hygiene product in accordance with the present disclosure is configured as an incontinence brief, a surgical gown, or a feminine hygiene product.

The following examples and representative procedures illustrate features in accordance with the present disclosure, and are provided solely by way of illustration. They are not intended to limit the scope of the appended claims or their equivalents.

### Examples

### General

For production of the example films, an extrusion cast line with up to 3 extruders was used. The A and B extruders are 2½ inches in diameter, and the C extruder is 1¾ inches in diameter. The extruders feed into a combining feedblock manufactured by Cloeren Corporation of Orange, Tex., which can layer the A, B and C extruder outputs in a variety of configurations. From the feedblock, the molten polymer proceeds into a monolayer cast die (manufactured by Cloeren) that is about 36 inches wide. The die has an adjustable gap. For the samples described herein, the adjustable gap was maintained between 10 and 40 mils. The molten polymer drops down to a chill roll. For the samples described herein, the chill roll had an embossed pattern FST-250 which was engraved by Pamarco of Roselle, N.J. as their pattern P-2739. The embossed pattern P-2739 is a square pattern (e.g., with lines nearly aligned with the Machine Direction) with 250 squares per inch and a depth of about 31 microns. The roll itself has an 18 inches diameter with internal water cooling. The engrave roll pattern may be replaced with other patterns that are shallow enough not to interfere with a vacuum box quench. One alternative is a 40 Ra pattern (40 micro-inch average roughness) generated by a sand-blasting process on a chrome plated roll.

### Example 1—Comparison of Conventional Embossed Film to Chill Cast Vacuum Box Film

In this experiment, microporous breathable films were made from the formulation XC3-121-2205.0 shown in Table 1.

TABLE 1
Composition of XC3-121-2205.0

| | | | Amount of |
|---|---|---|---|
| | Layer % | | Component |
| EXTRUDER | (Total) | COMPONENT | (Weight %) |
| A | 97 | T994L3 | 75 |
| | | (CaCO₃) | |
| | | 3527 | 15 |
| | | (metallocene | |
| | | polyethylene) | |
| | | 640 | 10 |
| | | (LDPE) | |
| C | 1.5/1.5 | LD516.LN | 100 |
| (split) | | (polyethylene) | |

The molten web formed by extrusion of the composition XC3-121-2205.0 shown in Table 1 was quenched by either a conventional embossed roll process or a chill cast vacuum box process in accordance with the present disclosure on a 250T roll (1749.9 rpm setting). The physical properties of a film made by the conventional embossed roll process and a film made by the chill cast process in accordance with the present disclosure are shown in Table 2. Table 2 further includes physical properties for a third film made by the chill cast vacuum box process, which was down-gauged to 12.21 gsm. In Table 2 and in subsequent tables, Elmendorf tear results that are below the assay range of the equipment are indicated by an asterisk and should be regarded as being for reference only.

TABLE 2
Comparison of Physical Properties of Patterned Microporous
Breathable Film Prepared by Conventional Embossing Process
vs. Chill Cast Vacuum Box Process.

| | | | | Down- |
|---|---|---|---|---|
| | | | | Gauged |
| | | Embossed | Chill | Chill |
| Physical Property | Units | FST250 | Cast | Cast |
| Basis Weight | g/m² | 16.60 | 16.60 | 12.21 |
| Emboss Depth | mil | 0.90 | 0.70 | 0.60 |
| Light Transmission | % | 43.3 | 40.5 | 47.7 |
| COF, Static - In\In | Index | 0.56 | 0.54 | 0.56 |
| COF, Static - Out\Out | Index | 0.58 | 0.57 | 0.57 |
| COF, Kinetic - In\In | Index | 0.53 | 0.51 | 0.53 |
| COF, Kinetic - Out\Out | Index | 0.56 | 0.56 | 0.52 |
| WVTR 100K | g/m²/day | 4109 | 2276 | 2569 |
| Force @ Peak MD | g/in | 563 | 695 | 584 |
| Strain @ Peak MD | % | 292 | 164 | 83 |
| Force @ Break MD | g/in | 563 | 695 | 581 |
| Strain @ Break MD | % | 292 | 164 | 93 |
| Force @ Yield MD | g/in | 402 | 624 | 429 |
| Strain @ Yield MD | % | 13 | 13 | 8 |
| Force @ 5% Strain MD | g/in | 285 | 360 | 316 |
| Force @ 10% Strain MD | g/in | 385 | 575 | 515 |
| Force @ 25% Strain MD | g/in | 429 | 670 | 577 |
| Force @ 50% Strain MD | g/in | 438 | 669 | 576 |
| Force @ 100% Strain | g/in | 447 | 673 | — |
| MD | | | | |
| Elmendorf Tear MD | gf | 32.3* | 19.2* | 9.3* |
| Force @ Peak TD | g/in | 337 | 334 | 245 |
| Strain @ Peak TD | % | 523 | 492 | 516 |
| Force @ Break TD | g/in | 337 | 334 | 245 |
| Strain @ Break TD | % | 523 | 492 | 515 |
| Force @ Yield TD | g/in | 206 | 228 | 161 |
| Strain @ Yield TD | % | 24 | 24 | 25 |
| Force @ 5% Strain TD | g/in | 126 | 145 | 100 |
| Force @ 10% Strain TD | g/in | 162 | 184 | 126 |
| Force @ 25% Strain TD | g/in | 208 | 231 | 161 |
| Force @ 50% Strain TD | g/in | 225 | 248 | 176 |
| Force @ 100% Strain | g/in | 227 | 248 | 175 |
| TD | | | | |
| Elmendorf Tear TD | gf | 275 | 451 | 324 |
| § Slow Puncture - ¼″ | gf | 234 | 282 | 214 |
| (D3) | | | | |

As shown by the data in Table 2, a microporous breathable film in accordance with the present disclosure shows substantially improved TD tear, and puncture properties as compared to a conventional embossed roll film. For example, microporous breathable films prepared by the chill cast process show greater MD tensile strength and less MD elongation as compared to the embossed film. Moreover, surprisingly, the non-embossed microporous breathable film exhibits a reduced water vapor transmission rate (WVTR) as compared to the comparable embossed film. This observation stands in contrast to the findings reported in U.S. Pat. No. 6,656,581, which states that the MVTR (moisture vapor transmission rate) of a non-embossed film is greater than the MVTR of a comparable embossed film that is incrementally stretched under essentially the same conditions.

The embossed process is prone to draw resonance. As a result, microporous breathable films prepared by a conventional embossing process typically include LDPE to assist in the processing. However, for microporous breathable films prepared by a chill cast vacuum box quenching process in accordance with the present teachings, the LDPE may be omitted, thereby affording stronger films having properties that were heretofore unachievable with conventional films.

### Example 2—Microporous Breathable Films Prepared by Vacuum Box Process

Seven formulations containing a CaCO₃-containing compound (CF7414 or T998K5) were used to prepare microporous breathable films in accordance with the present disclosure. In each of these seven formulations, the CaCO₃-containing compound (CF7414 or T998K5) is present in 70% by weight and PPA is present in 2%. The remainder of the formulations is a polymer or polymer blend. The composition of the seven formulations, including the compositions of the polymer/polymer blend constituting the balance, is shown in Table 3 below.

TABLE 3
Formulations for Microporous Breathable Films.

| | CaCO₃ | |
|---|---|---|
| | Compound | |
| Formulation | 70% | Polymer/Polymer Blend |
| No. | (w/w) | 28% (w/w) |
| 1 | CF7414 | 18% EXCEED LL3527 (ExxonMobil, metallocene |
| | | polyethylene resin, narrow MWD, density = 0.927 g/cm³)/ |
| | | 10% Dow 640 (DOW Chemical Company, low density |
| | | polyethylene resin, autoclave, branched broad MWD, |
| | | density = 0.922 g/cm³) |
| 2 | CF7414 | 28% LL3527 |
| 3 | CF7414 | 28% EXCEED LL3518 (ExxonMobil, metallocene |
| | | polyethylene resin, narrow MWD, density = 0.918 g/cm³) |
| 4 | CF7414 | 28% EXCEED LL1018 (ExxonMobil, metallocene |
| | | polyethylene resin, narrow MWD, density = 0.918 g/cm³) |
| 5 | CF7414 | 28% D350 (Chevron Phillips, MARFLEX linear low |
| | | density polyethylene, density = 0.933 g/cm³) |
| 6 | T998K5 | 18% LL3527, 10% Dow 640 |
| 7 | T998K5 | 28% LL3527 |

The films made from formulations 1 and 6 were 14 gsm, whereas films made from formulations 2-5 and 7 were 12 gsm.

The composition of the CaCO₃-containing compounds CF7414 and T998K5 shown in Table 3 are specified in Table 4 below.

TABLE 4
Composition of CaCO₃ Compounds used in the Formulations of Table 3.

| | CF7414 | T998K5 |
|---|---|---|
| Component | Amount of Component | Amount of Component |
| EXCEED LL3518 | 28 | |
| EXCEED LL3527 | | 26 |
| FilmLink 500 | 60 | 60 |
| (CaCO₃) | | |
| TiO2 | 12 | 14 |

The seven formulations shown in Table 3 were used to make a series of microporous breathable films. The films were subjected to varying amounts of pre-stretch and, in some cases to MD IMG stretching. The physical properties of the films thus prepared are summarized in Tables 5, 6, and 7 below.

TABLE 5
Physical Properties of Microporous Breathable Films A-G.

| | | A | B | C | D | E | F | G |
|---|---|---|---|---|---|---|---|---|
| | | Formulation | | | | | | |
| | | XC1-2- | XC1-2- | XC1-2- | XC1-2- | XC1-2- | XC1-2- | XC1-2- |
| | | 2251.0 | 2251.0 | 2251.0 | 2251.1 | 2251.1 | 2251.1 | 2251.2 |
| | | Pre-stretch | | | | | | |
| | | 50 | 70 | 50 | 50 | 70 | 50 | 50 |
| | | MD IMG? | | | | | | |
| | | No | No | Yes | No | No | Yes | No |
| | | Polymer/Polymer Blend | | | | | | |
| | | Blend | Blend | Blend | | | | |
| | | 3527/640 | 3527/640 | 3527/640 | Sole 3527 | Sole 3527 | Sole 3527 | Sole 3518 |
| | | Compound | | | | | | |
| | | CF7414 | CF7414 | CF7414 | CF7414 | CF7414 | CF7414 | CF7414 |
| Physical Property | Units | A | B | C | D | E | F | G |
| Basis Weight | g/m² | 13.60 | 13.61 | 13.07 | 11.32 | 12.19 | 11.63 | 11.31 |
| Density | g/cc | 1.4052 | 1.4655 | 1.4089 | 1.4752 | 1.4010 | 1.4636 | 1.3619 |
| Light Transmission | % | 41.8 | 39.3 | 42.1 | 46.3 | 44.4 | 45.3 | 49.1 |
| Gloss-In | % @ 45° | 9.5 | 9.2 | 8.8 | 6.7 | 6.9 | 7.2 | 7.0 |
| Gloss-Out | % @ 45° | 9.1 | 8.7 | 9.1 | 7.0 | 6.9 | 7.3 | 7.1 |
| COF, Static-In\In | — | 0.500 | 0.535 | 0.552 | 0.580 | 0.618 | 0.625 | 0.610 |
| COF, Static- | — | 0.548 | 0.517 | 0.530 | 0.600 | 0.612 | 0.607 | 0.620 |
| Out\Out | | | | | | | | |
| COF, Kinetic-In\In | — | 0.451 | 0.458 | 0.456 | 0.486 | 0.503 | 0.490 | 0.519 |
| COF, Kinetic- | — | 0.450 | 0.460 | 0.459 | 0.494 | 0.499 | 0.486 | 0.518 |
| Out\Out | | | | | | | | |
| WVTR 100K | g/m²/day | 4186 | 3652 | 3957 | 4439 | 3755 | 3719 | 2703 |
| Tensile Gauge MD | mil | 0.38 | 0.37 | 0.37 | 0.30 | 0.34 | 0.31 | 0.33 |
| Force @ Peak MD | g/in | 737 | 1,015 | 806 | 690 | 887 | 660 | 861 |
| Strain @ Peak MD | % | 148 | 177 | 154 | 217 | 220 | 193 | 224 |
| Force @ Break MD | g/in | 694 | 969 | 746 | 675 | 844 | 650 | 844 |
| Strain @ Break MD | % | 154 | 180 | 158 | 219 | 222 | 193 | 225 |
| Force @ Yield MD | g/in | 665 | 813 | 712 | 274 | 250 | 278 | 210 |
| Strain @ Yield MD | % | 15 | 15 | 15 | 11 | 8 | 11 | 9 |
| Force @ 5% | g/in | 274 | 314 | 272 | 191 | 205 | 186 | 139 |
| Strain MD | | | | | | | | |
| Force @ 10% | g/in | 522 | 607 | 528 | 270 | 295 | 272 | 215 |
| Strain MD | | | | | | | | |
| Force @ 25% | g/in | 681 | 839 | 731 | 323 | 361 | 334 | 272 |
| Strain MD | | | | | | | | |
| Force @ 50% | g/in | 662 | 817 | 708 | 343 | 387 | 358 | 303 |
| Strain MD | | | | | | | | |
| Force @ 100% | g/in | 675 | 838 | 721 | 369 | 420 | 390 | 353 |
| Strain MD | | | | | | | | |
| TEA MD | FtLb/in² | 976 | 1,485 | 1,103 | 1,099 | 1,179 | 942 | 1,061 |
| Elmendorf Tear | g | 200 | 200 | 200 | 200 | 200 | 200 | 200 |
| MD Arm | | | | | | | | |
| Elmendorf Tear | gf | 6.7* | 6.2* | 7* | 13.8* | 9.4* | 14.2* | 16.1* |
| MD | | | | | | | | |
| Tensile Gauge TD | mil | 0.38 | 0.37 | 0.37 | 0.30 | 0.34 | 0.31 | 0.33 |
| Force @ Peak TD | g/in | 270 | 229 | 256 | 204 | 212 | 194 | 184 |
| Strain @ Peak TD | % | 403 | 422 | 468 | 403 | 407 | 400 | 445 |
| Force @ Break TD | g/in | 259 | 217 | 245 | 194 | 204 | 185 | 177 |
| Strain @ Break TD | % | 410 | 429 | 472 | 408 | 411 | 404 | 450 |
| Force @ Yield TD | g/in | 173 | 159 | 167 | 160 | 163 | 143 | 125 |
| Strain @ Yield TD | % | 21 | 25 | 26 | 31 | 31 | 28 | 27 |
| Force @ 5% | g/in | 99 | 89 | 88 | 77 | 79 | 76 | 72 |
| Strain TD | | | | | | | | |
| Force @ 10% | g/in | 135 | 119 | 124 | 106 | 108 | 100 | 95 |
| Strain TD | | | | | | | | |
| Force @ 25% | g/in | 180 | 158 | 166 | 151 | 153 | 140 | 123 |
| Strain TD | | | | | | | | |
| Force @ 50% | g/in | 182 | 171 | 179 | 171 | 176 | 149 | 137 |
| Strain TD | | | | | | | | |
| Force @ 100% | g/in | 197 | 178 | 181 | 171 | 175 | 160 | 139 |
| Strain TD | | | | | | | | |
| TEA TD | FtLb/in² | 859 | 809 | 934 | 875 | 803 | 788 | 738 |
| Elmendorf Tear | g | 1,600 | 800 | 1,600 | 1,600 | 1,600 | 1,600 | 1,600 |
| TD Arm | | | | | | | | |
| Elmendorf Tear TD | gf | 330 | 247 | 301 | 312 | 378 | 335 | 355 |
| Dart Drop (26″) | g | 63 | 67 | 62 | 124 | 128 | 125 | 141 |
| § Slow Puncture- | gf | 311 | 332 | 277 | 214 | 229 | 213 | 195 |
| 1/4″ (D3) | | | | | | | | |

TABLE 6
Physical Properties of Microporous Breathable Films H-N.

| | | H | I | J | K | L | M | N |
|---|---|---|---|---|---|---|---|---|
| | | Formulation | | | | | | |
| | | XC1-2- | XC1-2- | XC1-2- | XC1-2- | XC1-2- | XC1-2- | XC1-2- |
| | | 2251.2 | 2251.2 | 2251.3 | 2251.3 | 2251.3 | 2251.4 | 2251.4 |
| | | Pre-stretch | | | | | | |
| | | 70 | 50 | 50 | 70 | 50 | 50 | 70 |
| | | MD IMG? | | | | | | |
| | | No | Yes | No | No | Yes | No | No |
| | | Polymer/Polymer Blend | | | | | | |
| | | Sole 3518 | Sole 3518 | Sole 1018 | Sole 1018 | Sole 1018 | Sole D350 | Sole D350 |
| | | Compound | | | | | | |
| | | CF7414 | CF7414 | CF7414 | CF7414 | CF7414 | CF7414 | CF7414 |
| Physical Property | Units | H | I | J | K | L | M | N |
| Basis Weight | g/m² | 11.45 | 11.37 | 11.25 | 11.48 | 11.56 | 11.79 | 11.05 |
| Density | g/cc | 1.4603 | 1.3375 | 1.4667 | 1.3047 | 1.4626 | 1.4212 | 1.4600 |
| Light Transmission | % | 46.1 | 47.4 | 45.9 | 45.0 | 45.1 | 43.6 | 43.7 |
| Gloss-In | % @ 45° | 6.9 | 7.1 | 6.9 | 7.1 | 7.0 | 6.4 | 7.1 |
| Gloss-Out | % @ 45° | 7.2 | 7.4 | 7.2 | 7.3 | 7.1 | 7.4 | 7.2 |
| COF, Static-In\In | — | 0.652 | 0.630 | 0.625 | 0.622 | 0.617 | 0.600 | 0.600 |
| COF, Static- | — | 0.650 | 0.640 | 0.640 | 0.628 | 0.627 | 0.593 | 0.567 |
| Out\Out | | | | | | | | |
| COF, Kinetic-In\In | — | 0.524 | 0.523 | 0.508 | 0.515 | 0.515 | 0.481 | 0.483 |
| COF, Kinetic- | — | 0.526 | 0.535 | 0.521 | 0.524 | 0.522 | 0.484 | 0.479 |
| Out\Out | | | | | | | | |
| WVTR 100K | g/m²/day | 2614 | 2574 | 1054 | 1140 | 1395 | 2807 | 2735 |
| Tensile Gauge MD | mil | 0.31 | 0.33 | 0.30 | 0.35 | 0.31 | 0.33 | 0.30 |
| Force @ Peak MD | g/in | 944 | 754 | 1,298 | 1,487 | 1,436 | 1,297 | 1,335 |
| Strain @ Peak MD | % | 202 | 198 | 153 | 137 | 148 | 178 | 150 |
| Force @ Break MD | g/in | 912 | 742 | 1,245 | 1,403 | 1,400 | 1,241 | 1,297 |
| Strain @ Break MD | % | 202 | 199 | 154 | 138 | 148 | 179 | 150 |
| Force @ Yield MD | g/in | 274 | 218 | 230 | 177 | 215 | 341 | 381 |
| Strain @ Yield MD | % | 10 | 10 | 8 | 6 | 8 | 10 | 10 |
| Force @ 5% | g/in | 185 | 143 | 158 | 161 | 142 | 201 | 216 |
| Strain MD | | | | | | | | |
| Force @ 10% | g/in | 278 | 222 | 273 | 294 | 267 | 339 | 370 |
| Strain MD | | | | | | | | |
| Force @ 25% | g/in | 353 | 285 | 393 | 450 | 406 | 468 | 542 |
| Strain MD | | | | | | | | |
| Force @ 50% | g/in | 394 | 318 | 472 | 560 | 499 | 508 | 598 |
| Strain MD | | | | | | | | |
| Force @ 100% | g/in | 462 | 373 | 664 | 882 | 755 | 628 | 802 |
| Strain MD | | | | | | | | |
| TEA MD | FtLb/in² | 1,219 | 902 | 1,173 | 1,041 | 1,176 | 1,350 | 1,351 |
| Elmendorf Tear | g | 200 | 200 | 200 | 200 | 200 | 200 | 200 |
| MD Arm | | | | | | | | |
| Elmendorf Tear | gf | 14.7* | 18.2* | 6.4* | 4.6* | 5.6* | 4.4* | 5* |
| MD | | | | | | | | |
| Tensile Gauge TD | mil | 0.31 | 0.33 | 0.30 | 0.35 | 0.31 | 0.33 | 0.30 |
| Force @ Peak TD | g/in | 201 | 201 | 221 | 199 | 194 | 254 | 218 |
| Strain @ Peak TD | % | 521 | 482 | 500 | 503 | 464 | 505 | 487 |
| Force @ Break TD | g/in | 189 | 193 | 207 | 189 | 189 | 246 | 210 |
| Strain @ Break TD | % | 525 | 485 | 503 | 505 | 468 | 508 | 492 |
| Force @ Yield TD | g/in | 113 | 122 | 128 | 115 | 122 | 174 | 153 |
| Strain @ Yield TD | % | 24 | 25 | 20 | 18 | 19 | 27 | 28 |
| Force @ 5% | g/in | 70 | 74 | 88 | 85 | 85 | 89 | 84 |
| Strain TD | | | | | | | | |
| Force @ 10% | g/in | 90 | 96 | 110 | 103 | 106 | 123 | 111 |
| Strain TD | | | | | | | | |
| Force @ 25% | g/in | 114 | 123 | 133 | 121 | 127 | 170 | 149 |
| Strain TD | | | | | | | | |
| Force @ 50% | g/in | 128 | 136 | 144 | 131 | 138 | 179 | 160 |
| Strain TD | | | | | | | | |
| Force @ 100% | g/in | 129 | 137 | 144 | 132 | 139 | 176 | 162 |
| Strain TD | | | | | | | | |
| TEA TD | FtLb/in² | 908 | 818 | 994 | 779 | 832 | 1,101 | 1,052 |
| Elmendorf Tear | g | 1,600 | 800 | 1,600 | 1,600 | 800 | 1,600 | 1,600 |
| TD Arm | | | | | | | | |
| Elmendorf Tear TD | gf | 312 | 320 | 396 | 364 | 347 | 417 | 297 |
| Dart Drop (26″) | g | 129 | 146 | 179 | 200 | 197 | 160 | 154 |
| § Slow Puncture- | gf | 209 | 208 | 285 | 283 | 282 | 296 | 275 |
| 1/4″ (D3) | | | | | | | | |

TABLE 7
Physical Properties of Microporous Breathable Films O-U.

| | | O | P | Q | R | S | T | U |
|---|---|---|---|---|---|---|---|---|
| | | Formulation | | | | | | |
| | | XC1-2- | XC1-2- | XC1-2- | XC1-2- | XC1-2- | XC1-2- | XC1-2- |
| | | 2251.4 | 2251.5 | 2251.5 | 2251.5 | 2251.6 | 2251.6 | 2251.6 |
| | | Pre-stretch | | | | | | |
| | | 50 | 50 | 70 | 50 | 50 | 70 | 50 |
| | | MD IMG? | | | | | | |
| | | Yes | No | No | Yes | No | No | Yes |
| | | Polymer/Polymer Blend | | | | | | |
| | | | Blend 3527 | Blend 3527 | Blend 3527 | | | |
| | | Sole D350 | 640 | 640 | 640 | Sole 3527 | Sole 3527 | Sole 3527 |
| | | Compound | | | | | | |
| | | CF7414 | T998K5 | T998K5 | T998K5 | T998K5 | T998K5 | T998K5 |
| Physical Property | Units | O | P | Q | R | S | T | U |
| Basis Weight | g/m² | 11.37 | 13.24 | 13.67 | 13.59 | 12.23 | 12.19 | 12.20 |
| Density | g/cc | 1.4289 | 1.4489 | 1.3988 | 1.4491 | 1.4211 | 1.4426 | 1.4135 |
| Light Transmission | % | 44.4 | 43.0 | 41.2 | 42.4 | 45.5 | 46.1 | 45.2 |
| Gloss-In | % @ 45° | 7.3 | 8.6 | 8.8 | 8.7 | 6.8 | 6.9 | 6.6 |
| Gloss-Out | % @ 45° | 7.3 | 9.0 | 8.9 | 8.7 | 7.0 | 6.8 | 6.9 |
| COF, Static-In\In | — | 0.593 | 0.553 | 0.513 | 0.518 | 0.598 | 0.587 | 0.585 |
| COF, Static- | — | 0.597 | 0.510 | 0.523 | 0.493 | 0.537 | 0.565 | 0.565 |
| Out\Out | | | | | | | | |
| COF, Kinetic-In\In | — | 0.498 | 0.456 | 0.440 | 0.451 | 0.465 | 0.472 | 0.465 |
| COF, Kinetic- | — | 0.483 | 0.441 | 0.436 | 0.440 | 0.460 | 0.461 | 0.464 |
| Out\Out | | | | | | | | |
| WVTR 100K | g/m²/day | 2610 | 3949 | 5316 | 5031 | 6446 | 6024 | 5829 |
| Tensile Gauge MD | mil | 0.31 | 0.36 | 0.38 | 0.37 | 0.35 | 0.33 | |
| Force @ Peak MD | g/in | 1,354 | 854 | 863 | 891 | 693 | 715 | 764 |
| Strain @ Peak MD | % | 175 | 157 | 175 | 192 | 241 | 206 | 247 |
| Force @ Break MD | g/in | 1,278 | 797 | 844 | 865 | 684 | 685 | 764 |
| Strain @ Break MD | % | 176 | 174 | 177 | 195 | 241 | 207 | 247 |
| Force @ Yield MD | g/in | 357 | 670 | 614 | 783 | 304 | 314 | 310 |
| Strain @ Yield MD | % | 10 | 13 | 11 | 15 | 11 | 11 | 11 |
| Force @ 5% | g/in | 208 | 329 | 293 | 333 | 218 | 212 | 213 |
| Strain MD | | | | | | | | |
| Force @ 10% | g/in | 352 | 589 | 557 | 600 | 298 | 304 | 304 |
| Strain MD | | | | | | | | |
| Force @ 25% | g/in | 493 | 787 | 774 | 798 | 344 | 368 | 354 |
| Strain MD | | | | | | | | |
| Force @ 50% | g/in | 536 | 758 | 743 | 766 | 354 | 384 | 364 |
| Strain MD | | | | | | | | |
| Force @ 100% | g/in | 666 | 762 | 751 | 768 | 367 | 405 | 377 |
| Strain MD | | | | | | | | |
| TEA MD | FtLb/in² | 1,477 | 1,342 | 1,271 | 1,487 | 1,056 | 1,018 | |
| Elmendorf Tear | g | 200 | 200 | 200 | 200 | 200 | 200 | 200 |
| MD Arm | | | | | | | | |
| Elmendorf Tear | gf | 4.9* | 5* | 4.6* | 5.4* | 16.2* | 13.4* | 14.9* |
| MD | | | | | | | | |
| Tensile Gauge TD | mil | 0.31 | 0.36 | 0.38 | 0.37 | 0.35 | 0.33 | 0.34 |
| Force @ Peak TD | g/in | 224 | 265 | 291 | 258 | 261 | 217 | 274 |
| Strain @ Peak TD | % | 476 | 449 | 504 | 445 | 463 | 402 | 464 |
| Force @ Break TD | g/in | 216 | 256 | 280 | 247 | 251 | 200 | 267 |
| Strain @ Break TD | % | 481 | 454 | 508 | 452 | 466 | 409 | 467 |
| Force @ Yield TD | g/in | 161 | 204 | 197 | 198 | 190 | 172 | 193 |
| Strain @ Yield TD | % | 28 | 27 | 29 | 27 | 30 | 30 | 29 |
| Force @ 5% | g/in | 90 | 102 | 100 | 102 | 84 | 81 | 88 |
| Strain TD | | | | | | | | |
| Force @ 10% | g/in | 117 | 143 | 138 | 141 | 121 | 113 | 127 |
| Strain TD | | | | | | | | |
| Force @ 25% | g/in | 157 | 199 | 190 | 194 | 182 | 164 | 186 |
| Strain TD | | | | | | | | |
| Force @ 50% | g/in | 170 | 217 | 212 | 213 | 202 | 186 | 206 |
| Strain TD | | | | | | | | |
| Force @ 100% | g/in | 168 | 211 | 209 | 208 | 197 | 183 | 201 |
| Strain TD | | | | | | | | |
| TEA TD | FtLb/in² | 1,021 | 1,013 | 1,100 | 964 | 1,008 | 850 | 1,087 |
| Elmendorf Tear | g | 1,600 | 1,600 | 1,600 | 1,600 | 800 | 1,600 | 1,600 |
| TD Arm | | | | | | | | |
| Elmendorf Tear TD | gf | 323 | 414 | 350 | 453 | 274 | 380 | 340 |
| Dart Drop (26″) | g | 169 | 64 | 62 | 59 | 125 | 124 | 112 |
| § Slow Puncture- | gf | 275 | 284 | 307 | 279 | 243 | 232 | 237 |
| 1/4″ (D3) | | | | | | | | |

### Example 3—Comparative Examples Showing Physical Properties of Conventional Microporous Breathable Films

Data for a series of microporous breathable films prepared by conventional methods (e.g., Windmoeller & Hoelscher blown MDO film, cast MDO films, and cast IMG films) are shown in Table 8 below. Data for a series of microporous breathable films prepared by a vacuum box process in accordance with the present teachings are shown in Table 9 below.

As shown by the data in Table 8, the blown MDO film exhibits poor strain and tear properties. Moreover, the strain at peak MD corresponding to the films in Table 9 are substantially higher than those in Table 8. In addition, the films in Table 9 exhibit excellent Dart Drop and slow puncture characteristics.

TABLE 8
Comparative Data for Microporous Breathable Films Prepared by Conventional Processes.

| | | | | | XC5- | XC5- | XC3- | |
|---|---|---|---|---|---|---|---|---|
| | | | | | 121- | 121- | 121- | XC3-121- |
| | | | | | 2265.0 | 2265.1 | 2218.1M | 2224.0 |
| | | W&H | XP8790C1 | XP8790C | (3518/ | (3527/ | 16 gsm | 16 gsm |
| | | Blown | (Cast | (Cast | FilmLink | FilmLink | (Cast | (Cast IMG) |
| Physical Property | Units | MDO | MDO) | MDO) | 500) | 500) | IMG) | (MCA data) |
| Basis Weight | gsm | | 16.7 | 19.2 | 15.5 | 15.4 | 17.42 | 15.8 |
| Gauge | mil | 0.55 | 0.52 | | | | 0.45 | |
| WVTR 100K | g/m²/ | 3741 | 6640 | | 6963 | 16577 | 3754 | 3972 |
| | day | | | | | | | |
| Force @ Peak MD | g/in | 2,167 | 2752 | 2784 | 2510 | 2318 | 950 | 1111 |
| Strain @ Peak MD | % | 58 | 85 | 139 | 84 | 83 | 193 | 179 |
| Force @ 5% Strain MD | g/in | 487 | | 361 | | | 388 | |
| Force @ 10% Strain MD | g/in | 842 | | 616 | | | 652 | |
| Force @ 25% Strain MD | g/in | 1,765 | 1158 | 1023 | 1070 | 1305 | 734 | 814 |
| Force @ 50% Strain MD | g/in | 2,080 | | 1441 | | | 734 | |
| Elmendorf Tear MD | gf | 2 | | 7 | | | 7.4 | |
| Force @ Peak TD | g/in | 211 | 268 | 285 | 288 | 296 | 256 | 341 |
| Strain @ Peak TD | % | 25 | 394 | 377 | 215 | 336 | 458 | 473 |
| Force @ 5% Strain TD | g/in | 149 | | 174 | | | 117 | |
| Force @ 10% Strain TD | g/in | 194 | | 229 | | | 158 | |
| Force @ 25% Strain TD | g/in | 210 | 240 | 270 | 215 | 233 | 198 | 236 |
| Force @ 50% Strain TD | g/in | 202 | | 267 | | | 202 | |
| Elmendorf Tear TD | gf | 73 | | 126 | | | 146 | |

TABLE 9
Physical Properties of Microporous Breathable Films V-AA.

| | | Stretching | | | | | |
|---|---|---|---|---|---|---|---|
| | | | | 50% | | | 50% |
| | | | | Pre- | | | Pre- |
| | | 50% | 70% | stretch | 50% | 70% | stretch |
| | | Pre- | Pre- | w/MD | Pre- | Pre- | w/MD |
| | | stretch | stretch | IMG | stretch | stretch | IMG |
| | | Polymer/Polymer Blend | | | | | |
| | | | | | Blend | Blend | Blend |
| | | Sole | Sole | | 3518/ | 3518/ | 3518/ |
| | | 3518 | 3518 | | D350 | D350 | D350 |
| Physical Property | Units | V | W | X | Y | Z | AA |
| Basis Weight | gsm | 11.32 | 12.19 | 11.63 | 11.79 | 11.05 | 11.37 |
| Gauge | mil | 0.3 | 0.34 | 0.31 | 0.33 | 0.3 | 0.31 |
| WVTR 100K | g/m²/day | 4439 | 3755 | 3719 | 2807 | 2735 | 2610 |
| Force @ Peak MD | g/in | 690 | 887 | 660 | 1297 | 1335 | 1354 |
| Strain @ Peak MD | % | 217 | 220 | 193 | 178 | 150 | 175 |
| Force @ 5% Strain MD | g/in | 191 | 205 | 186 | 201 | 216 | 208 |
| Force @ 10% Strain MD | g/in | 270 | 295 | 272 | 339 | 370 | 352 |
| Force @ 25% Strain MD | g/in | 323 | 361 | 334 | 468 | 542 | 493 |
| Force @ 50% Strain MD | g/in | 343 | 387 | 358 | 508 | 598 | 536 |
| Elmendorf Tear MD | gf | 13.8 | 9.4 | 14.2 | 4.4 | 5 | 4.4 |
| Force @ Peak TD | g/in | 204 | 212 | 194 | 254 | 218 | 224 |
| Strain @ Peak TD | % | 403 | 407 | 400 | 505 | 487 | 476 |
| Force @ 5% Strain TD | g/in | 77 | 79 | 76 | 89 | 84 | 90 |
| Force @ 10% Strain TD | g/in | 106 | 108 | 100 | 123 | 111 | 117 |
| Force @ 25% Strain TD | g/in | 151 | 153 | 140 | 170 | 149 | 157 |
| Force @ 50% Strain TD | g/in | 171 | 175 | 160 | 179 | 160 | 170 |
| Elmendorf Tear TD | gf | 312 | 229 | 213 | 417 | 297 | 323 |
| Dart Drop | g | 124 | 128 | 125 | 160 | 154 | 169 |
| Slow Puncture | gf | 214 | 229 | 213 | 296 | 275 | 275 |

### Example 4—Skinless Microporous Breathable Films

A series of 16 skinless microporous breathable films having a structure BBBBB were prepared from the formulation XC1-2-2269.0 shown in Table 10. The composition of compound CF7414 is given above in Table 4.

The 16 films were subjected to the following different processing conditions: basis weights (9 gsm vs. 12 gsm), pre-stretch (35%/35% vs. 50%/50%), depth of engagement (0.070 vs. 0.085), and post-stretch (0% vs. 30%). The physical properties of the resultant films are summarized in Table 11-12.

TABLE 10
Composition of Formulation XC1-2-2269.0 Used to Make
BBBBB Skinless Microporous Breathable Films.

| | Component |
|---|---|
| B extruder | 70% Heritage CF7414 |
| (100%) | 28% LL3518 |
| | 1% Ampacet 102823 PA (process aid) |

In Tables 11-12, the legend W/X/Y/Z is a shorthand nomenclature signifying basis weight (gsm)/pre-stretch/depth of engagement of IMG rolls/post-stretch. For example, the designation 9/35/070/0 represents a basis weight of 9 gsm, 35%/35% pre-stretch, a depth of engagement of 70 mm, and 0% post-stretch.

TABLE 11
Physical Properties of Skinless Microporous Breathable Films A1-H1.

| | | A1 | B1 | C1 | D1 | E1 | F1 | G1 | H1 |
|---|---|---|---|---|---|---|---|---|---|
| | | W/X/Y/Z | | | | | | | |
| | | 9/35/ | 9/35/ | 9/35/ | 9/35/ | 9/50/ | 9/50/ | 9/50/ | 9/50/ |
| Physical Properties | Units | 070/0 | 070/30 | 085/0 | 085/30 | 070/0 | 070/30 | 085/0 | 085/30 |
| Gauge | mil | 0.20 | 0.24 | 0.24 | 0.24 | 0.25 | 0.24 | 0.23 | 0.25 |
| Basis Weight | g/m² | 7.74 | 8.58 | 8.95 | 8.76 | 9.12 | 8.79 | 8.70 | 9.08 |
| Density | g/cc | 1.4714 | 1.4226 | 1.4643 | 1.4338 | 1.4616 | 1.4713 | 1.4658 | 1.4061 |
| Emboss Depth | mil | 0.37 | 0.30 | 0.30 | 0.37 | 0.27 | 0.30 | 0.30 | 0.33 |
| Light Transmission | % | 56.2 | 51.7 | 54.1 | 48.4 | 53.1 | 50.1 | 50.5 | 47.7 |
| WVTR 100K | g/m²/ | 2414 | 4885 | 3892 | 5837 | 2329 | 5073 | 4541 | 8367 |
| | day | | | | | | | | |
| Tensile Gauge MD | mil | 0.21 | 0.24 | 0.24 | 0.24 | 0.25 | 0.24 | 0.23 | 0.25 |
| Force @ Peak MD | g/in | 687 | 878 | 566 | 570 | 682 | 747 | 657 | 988 |
| Strain @ Peak MD | % | 207 | 162 | 193 | 136 | 177 | 124 | 188 | 158 |
| Force @ Break MD | g/in | 675 | 878 | 566 | 570 | 682 | 747 | 657 | 988 |
| Strain @ Break MD | % | 207 | 162 | 193 | 136 | 177 | 124 | 188 | 158 |
| Force @ Yield MD | g/in | 186 | 191 | 171 | 186 | 196 | 181 | 145 | 205 |
| Strain @ Yield MD | % | 9 | 8 | 9 | 7 | 8 | 6 | 7 | 8 |
| Force @ 5% | g/in | 133 | 137 | 121 | 155 | 143 | 159 | 126 | 139 |
| Strain MD | | | | | | | | | |
| Force @ 10% | g/in | 194 | 217 | 177 | 225 | 211 | 244 | 187 | 236 |
| Strain MD | | | | | | | | | |
| Force @ 25% | g/in | 233 | 286 | 218 | 291 | 261 | 328 | 238 | 328 |
| Strain MD | | | | | | | | | |
| Force @ 50% | g/in | 259 | 340 | 245 | 343 | 294 | 399 | 273 | 395 |
| Strain MD | | | | | | | | | |
| Force @ 100% | g/in | 300 | 455 | 287 | 447 | 360 | 573 | 328 | 533 |
| Strain MD | | | | | | | | | |
| TEA MD | FtLb/ | 1,259 | 1,106 | 923 | 772 | 965 | 838 | 1,052 | 1,171 |
| | in² | | | | | | | | |
| Elmendorf Tear | g | 200 | 200 | 200 | 200 | 200 | 200 | 200 | 200 |
| MD Arm | | | | | | | | | |
| Elmendorf Tear | gf | 11.2* | 5.1* | 13* | 9.8* | 8* | 5.6* | 9.6* | 5.7* |
| MD | | | | | | | | | |
| Tensile Gauge TD | mil | 0.21 | 0.24 | 0.24 | 0.24 | 0.25 | 0.24 | 0.23 | 0.25 |
| Force @ Peak TD | g/in | 161 | 142 | 172 | 215 | 155 | 134 | 183 | 154 |
| Strain @ Peak TD | % | 518 | 485 | 417 | 449 | 493 | 495 | 476 | 460 |
| Force @ Break TD | g/in | 152 | 142 | 172 | 215 | 155 | 134 | 183 | 154 |
| Strain @ Break TD | % | 522 | 485 | 417 | 448 | 494 | 494 | 476 | 459 |
| Force @ Yield TD | g/in | 116 | 104 | 116 | 138 | 112 | 99 | 117 | 97 |
| Strain @ Yield TD | % | 26 | 22 | 26 | 30 | 24 | 22 | 29 | 26 |
| Force @ 5% | g/in | 74 | 62 | 59 | 64 | 70 | 61 | 65 | 44 |
| Strain TD | | | | | | | | | |
| Force @ 10% | g/in | 92 | 87 | 85 | 95 | 92 | 86 | 86 | 72 |
| Strain TD | | | | | | | | | |
| Force @ 25% | g/in | 115 | 105 | 113 | 132 | 112 | 102 | 111 | 96 |
| Strain TD | | | | | | | | | |
| Force @ 50% | g/in | 119 | 110 | 126 | 150 | 118 | 104 | 127 | 111 |
| Strain TD | | | | | | | | | |
| Force @ 100% | g/in | 115 | 106 | 125 | 150 | 114 | 102 | 126 | 113 |
| Strain TD | | | | | | | | | |
| TEA TD | FtLb/ | 1,112 | 823 | 836 | 1,091 | 868 | 795 | 1,013 | 786 |
| | in² | | | | | | | | |
| Elmendorf Tear | g | 800 | 800 | 800 | 800 | 800 | 800 | 800 | 800 |
| TD Arm | | | | | | | | | |
| Elmendorf Tear TD | gf | 293 | 246 | 223 | 215 | 246 | 239 | 240 | 240 |
| Dart Drop (26″) | g | 114 | 105 | 120 | 124 | 123 | 100 | 121 | 104 |
| § Slow Puncture- | gf | 134 | 164 | 149 | 209 | 164 | 193 | 173 | 196 |
| 1/4″ (D3) | | | | | | | | | |

TABLE 12
Physical Properties of Skinless Microporous Breathable Films Il-Pi.

| | | I1 | J1 | K1 | L1 | M1 | N1 | O1 | P1 |
|---|---|---|---|---|---|---|---|---|---|
| | | W/X/Y/Z | | | | | | | |
| | | 12/35/ | 12/35/ | 12/35/ | 12/35/ | 12/50/ | 12/50/ | 12/50/ | 12/50/ |
| Physical Properties | Units | 070/0 | 070/30 | 085/0 | 085/30 | 070/0 | 070/30 | 085/0 | 085/30 |
| Gauge | mil | 0.31 | 0.32 | 0.31 | 0.31 | 0.33 | 0.31 | 0.32 | 0.32 |
| Basis Weight | g/m² | 11.57 | 11.79 | 11.61 | 11.43 | 12.16 | 11.43 | 12.12 | 11.85 |
| Density | g/cc | 1.4601 | 1.4345 | 1.4606 | 1.4331 | 1.4597 | 1.4692 | 1.4277 | 1.4695 |
| Emboss Depth | mil | 0.43 | 0.43 | 0.50 | 0.40 | 1.07 | 0.57 | 1.00 | 0.63 |
| Light Transmission | % | 48.5 | 45.6 | 46.3 | 43.6 | 46.0 | 44.1 | 42.2 | 41.6 |
| WVTR 100K | g/m²/ | 3621 | 6457 | 5037 | 10038 | 3478 | 6026 | 5546 | 9365 |
| | day | | | | | | | | |
| Tensile Gauge MD | mil | 0.31 | 0.32 | 0.31 | 0.31 | 0.31 | 0.32 | 0.32 | 0.32 |
| Force @ Peak MD | g/in | 892 | 1,121 | 761 | 1,205 | 1,174 | 972 | 714 | 984 |
| Strain @ Peak MD | % | 257 | 207 | 259 | 207 | 252 | 159 | 207 | 168 |
| Force @ Break MD | g/in | 892 | 1,121 | 761 | 1,205 | 1,160 | 972 | 714 | 984 |
| Strain @ Break MD | % | 257 | 207 | 259 | 207 | 252 | 159 | 207 | 168 |
| Force @ Yield MD | g/in | 229 | 281 | 232 | 249 | 272 | 296 | 251 | 285 |
| Strain @ Yield MD | % | 9 | 9 | 10 | 9 | 9 | 9 | 10 | 9 |
| Force @ 5% | g/in | 168 | 201 | 169 | 164 | 189 | 210 | 181 | 201 |
| Strain MD | | | | | | | | | |
| Force @ 10% | g/in | 238 | 295 | 235 | 266 | 282 | 316 | 254 | 302 |
| Strain MD | | | | | | | | | |
| Force @ 25% | g/in | 280 | 367 | 279 | 353 | 345 | 411 | 311 | 392 |
| Strain MD | | | | | | | | | |
| Force @ 50% | g/in | 303 | 413 | 300 | 407 | 377 | 477 | 344 | 454 |
| Strain MD | | | | | | | | | |
| Force @ 100% | g/in | 337 | 489 | 330 | 494 | 427 | 595 | 392 | 558 |
| Strain MD | | | | | | | | | |
| TEA MD | FtLb/ | 1,315 | 1,354 | 1,230 | 1,422 | 1,652 | 1,027 | 1,003 | 1,069 |
| | in² | | | | | | | | |
| Elmendorf Tear | g | 200 | 200 | 200 | 200 | 200 | 200 | 200 | 200 |
| MD Arm | | | | | | | | | |
| Elmendorf Tear | gf | 21.4* | 8.5* | 24.8* | 12.5* | 15.2* | 7.3* | 18.4* | 6* |
| MD | | | | | | | | | |
| Tensile Gauge TD | mil | 0.31 | 0.32 | 0.31 | 0.31 | 0.31 | 0.31 | 0.32 | 0.32 |
| Force @ Peak TD | g/in | 220 | 185 | 257 | 208 | 186 | 188 | 231 | 185 |
| Strain @ Peak TD | % | 486 | 486 | 452 | 430 | 459 | 487 | 405 | 402 |
| Force @ Break TD | g/in | 220 | 185 | 256 | 206 | 186 | 187 | 231 | 184 |
| Strain @ Break TD | % | 486 | 486 | 452 | 430 | 461 | 487 | 406 | 401 |
| Force @ Yield TD | g/in | 156 | 134 | 150 | 142 | 146 | 138 | 168 | 127 |
| Strain @ Yield TD | % | 23 | 21 | 24 | 24 | 21 | 21 | 27 | 23 |
| Force @ 5% | g/in | 96 | 83 | 76 | 77 | 97 | 83 | 90 | 68 |
| Strain TD | | | | | | | | | |
| Force @ 10% | g/in | 127 | 112 | 112 | 108 | 123 | 116 | 123 | 98 |
| Strain TD | | | | | | | | | |
| Force @ 25% | g/in | 159 | 136 | 152 | 143 | 149 | 140 | 165 | 130 |
| Strain TD | | | | | | | | | |
| Force @ 50% | g/in | 161 | 141 | 164 | 155 | 152 | 143 | 186 | 148 |
| Strain TD | | | | | | | | | |
| Force @ 100% | g/in | 157 | 137 | 164 | 158 | 147 | 140 | 184 | 151 |
| Strain TD | | | | | | | | | |
| TEA TD | FtLb/ | 964 | 805 | 964 | 836 | 833 | 845 | 872 | 695 |
| | in² | | | | | | | | |
| Elmendorf Tear | g | 800 | 800 | 800 | 800 | 800 | 800 | 800 | 800 |
| TD Arm | | | | | | | | | |
| Elmendorf Tear TD | gf | 328 | 264 | 281 | 293 | 289 | 250 | 324 | 268 |
| Dart Drop (26″) | g | 141 | 116 | 144 | 125 | 160 | 109 | 153 | 141 |
| § Slow Puncture- | gf | 199 | 202 | 209 | 251 | 206 | 221 | 208 | 238 |
| 1/4″ (D3) | | | | | | | | | |

### Example 5—Skinned Microporous Breathable Films

A series of 16 skinned microporous breathable films having a structure CBBBC were prepared from the formulation XC1-22-2270.0 shown in Table 13. The composition of compound CF7414 is given above in Table 4.

The 16 films were subjected to the following different processing conditions: basis weights (9 gsm vs. 12 gsm), pre-stretch (35%/35% vs. 50%/50%), depth of engagement (0.07 vs. 0.085), and post-stretch (0% vs. 30%). The physical properties of the resultant films are summarized in Table 14-15.

TABLE 13
Composition of Formulation XC3-22-2270.0 Used to Make
CBBBC Skinned Microporous Breathable Films.

| | Component |
|---|---|
| B extruder | 70% Heritage CF7414 |
| (98%) | 28% LL3518 |
| C extruder | 100% MobilExxon LD516 |
| (2%) | |

In Tables 14-15, the legend W/X/Y/Z is a shorthand nomenclature signifying basis weight (gsm)/pre-stretch/depth of engagement of IMG rolls/post-stretch. For example, the designation 9/35/070/0 represents a basis weight of 9 gsm, 35%/35% pre-stretch, a depth of engagement of 70 mm, and 0 post-stretch.

TABLE 14
Physical Properties of Skinned Microporous Breathable Films A2-H2.

| | | A2 | B2 | C2 | D2 | E2 | F2 | G2 | H2 |
|---|---|---|---|---|---|---|---|---|---|
| | | W/X/Y/Z | | | | | | | |
| | | 9/35/ | 9/35/ | 9/35/ | 9/35/ | 9/50/ | 9/50/ | 9/50/ | 9/50/ |
| Physical Properties | Units | 070/0 | 070/30 | 085/0 | 085/30 | 070/0 | 070/30 | 085/0 | 085/30 |
| Gauge | mil | 0.25 | 0.25 | 0.25 | 0.25 | 0.24 | 0.30 | 0.25 | 0.26 |
| Basis Weight | g/m² | 9.27 | 9.01 | 9.13 | 9.10 | 8.90 | 10.88 | 9.07 | 9.45 |
| Density | g/cc | 1.4470 | 1.3980 | 1.4576 | 1.4211 | 1.4471 | 1.4183 | 1.4383 | 1.4182 |
| Emboss Depth | mil | 0.70 | 0.57 | 0.37 | 0.20 | 0.30 | 0.57 | 0.30 | 0.27 |
| Light Transmission | % | 53.9 | 51.6 | 51.0 | 49.2 | 52.3 | 46.0 | 50.6 | 46.4 |
| WVTR 100K | g/m²/ | 2632 | 3545 | 3950 | 5835 | 3104 | 4424 | 3941 | 6188 |
| | day | | | | | | | | |
| Tensile Gauge MD | mil | 0.25 | 0.25 | 0.25 | 0.25 | 0.24 | 0.30 | 0.25 | 0.26 |
| Force @ Peak MD | g/in | 722 | 882 | 665 | 661 | 675 | 1,031 | 611 | 754 |
| Strain @ Peak MD | % | 232 | 180 | 236 | 152 | 176 | 159 | 172 | 125 |
| Force @ Break MD | g/in | 722 | 882 | 665 | 661 | 675 | 1,031 | 611 | 754 |
| Strain @ Break MD | % | 232 | 180 | 236 | 152 | 176 | 159 | 172 | 125 |
| Force @ Yield MD | g/in | 139 | 201 | 215 | 258 | 237 | 252 | 225 | 171 |
| Strain @ Yield MD | % | 4 | 8 | 10 | 10 | 9 | 8 | 10 | 6 |
| Force @ 5% | g/in | 147 | 160 | 143 | 161 | 160 | 197 | 151 | 178 |
| Strain MD | | | | | | | | | |
| Force @ 10% | g/in | 221 | 253 | 214 | 253 | 242 | 318 | 228 | 284 |
| Strain MD | | | | | | | | | |
| Force @ 25% | g/in | 261 | 319 | 253 | 320 | 294 | 410 | 280 | 379 |
| Strain MD | | | | | | | | | |
| Force @ 50% | g/in | 285 | 363 | 275 | 368 | 329 | 474 | 315 | 450 |
| Strain MD | | | | | | | | | |
| Force @ 100% | g/in | 321 | 444 | 308 | 451 | 393 | 601 | 376 | 601 |
| Strain MD | | | | | | | | | |
| TEA MD | FtLb/ | 1,294 | 1,240 | 1,249 | 926 | 1,065 | 1,115 | 941 | 851 |
| | in² | | | | | | | | |
| Elmendorf Tear | g | 200 | 200 | 200 | 200 | 200 | 200 | 200 | 200 |
| MD Arm | | | | | | | | | |
| Elmendorf Tear | gf | 11* | 5.4* | 12.5* | 6.3* | 7* | 4.6* | 9.8* | 4.6* |
| MD | | | | | | | | | |
| Tensile Gauge TD | mil | 0.25 | 0.25 | 0.25 | 0.25 | 0.24 | 0.30 | 0.25 | 0.26 |
| Force @ Peak TD | g/in | 196 | 165 | 217 | 190 | 181 | 195 | 180 | 174 |
| Strain @ Peak TD | % | 540 | 510 | 464 | 465 | 514 | 524 | 461 | 440 |
| Force @ Break TD | g/in | 192 | 165 | 216 | 190 | 181 | 195 | 180 | 174 |
| Strain @ Break TD | % | 540 | 511 | 465 | 465 | 514 | 524 | 461 | 440 |
| Force @ Yield TD | g/in | 118 | 104 | 123 | 111 | 112 | 135 | 105 | 104 |
| Strain @ Yield TD | % | 24 | 23 | 28 | 29 | 24 | 20 | 28 | 26 |
| Force @ 5% | g/in | 68 | 58 | 56 | 53 | 66 | 89 | 56 | 54 |
| Strain TD | | | | | | | | | |
| Force @ 10% | g/in | 92 | 83 | 81 | 75 | 88 | 114 | 75 | 76 |
| Strain TD | | | | | | | | | |
| Force @ 25% | g/in | 119 | 106 | 118 | 106 | 112 | 138 | 102 | 103 |
| Strain TD | | | | | | | | | |
| Force @ 50% | g/in | 125 | 111 | 136 | 125 | 120 | 142 | 118 | 121 |
| Strain TD | | | | | | | | | |
| Force @ 100% | g/in | 122 | 112 | 136 | 128 | 119 | 140 | 121 | 125 |
| Strain TD | | | | | | | | | |
| TEA TD | FtLb/ | 1,080 | 917 | 1,025 | 940 | 1,029 | 969 | 887 | 824 |
| | in² | | | | | | | | |
| Elmendorf Tear | g | 1,600 | 1,600 | 1,600 | 1,600 | 1,600 | 1,600 | 1,600 | 1,600 |
| TD Arm | | | | | | | | | |
| Elmendorf Tear TD | gf | 277 | 246 | 220 | 262 | 271 | 225 | 248 | 233 |
| Dart Drop (26″) | g | 146 | 124 | 157 | 122 | 129 | 131 | 122 | 120 |
| § Slow Puncture- | gf | 152 | 177 | 158 | 197 | 167 | 224 | 182 | 220 |
| 1/4″ (D3) | | | | | | | | | |

TABLE 15
Physical Properties of Skinned Microporous Breathable Films I2-P2.

| | | I2 | J2 | K2 | L2 | M2 | N2 | O2 | P2 |
|---|---|---|---|---|---|---|---|---|---|
| | | W/X/Y/Z | | | | | | | |
| | | 12/35/ | 12/35/ | 12/35/ | 12/35/ | 12/50/ | 12/50/ | 12/50/ | 12/50/ |
| Physical Properties | Units | 070/0 | 070/30 | 085/0 | 085/30 | 070/0 | 070/30 | 085/0 | 085/30 |
| Gauge | mil | 0.34 | 0.34 | 0.34 | 0.32 | 0.34 | 0.35 | 0.32 | 0.34 |
| Basis Weight | g/m² | 12.30 | 12.00 | 12.24 | 11.46 | 12.53 | 12.39 | 11.81 | 12.21 |
| Density | g/cc | 1.4425 | 1.4087 | 1.4379 | 1.4065 | 1.4328 | 1.4101 | 1.4478 | 1.4234 |
| Emboss Depth | mil | 0.50 | 0.33 | 0.43 | 0.60 | 0.57 | 0.30 | 0.43 | 0.57 |
| Light Transmission | % | 49.3 | 46.2 | 45.7 | 44.2 | 46.3 | 43.5 | 44.9 | 40.8 |
| WVTR 100K | g/m²/ | 3160 | 4754 | 4917 | 8594 | 3567 | 4989 | 5350 | 8575 |
| | day | | | | | | | | |
| Tensile Gauge MD | mil | 0.34 | 0.34 | 0.34 | 0.32 | 0.34 | 0.35 | 0.32 | 0.34 |
| Force @ Peak MD | g/in | 945 | 1,067 | 818 | 1,123 | 1,117 | 1,216 | 1,014 | 1,143 |
| Strain @ Peak MD | % | 263 | 187 | 272 | 224 | 248 | 175 | 254 | 171 |
| Force @ Break MD | g/in | 945 | 1,066 | 817 | 1,122 | 1,117 | 1,216 | 1,014 | 1,141 |
| Strain @ Break MD | % | 263 | 187 | 272 | 224 | 248 | 175 | 254 | 171 |
| Force @ Yield MD | g/in | 280 | 309 | 270 | 302 | 292 | 364 | 271 | 264 |
| Strain @ Yield MD | % | 10 | 9 | 10 | 10 | 10 | 10 | 10 | 7 |
| Force @ 5% | g/in | 195 | 207 | 197 | 188 | 200 | 235 | 180 | 207 |
| Strain MD | | | | | | | | | |
| Force @ 10% | g/in | 281 | 317 | 271 | 295 | 295 | 367 | 271 | 331 |
| Strain MD | | | | | | | | | |
| Force @ 25% | g/in | 326 | 397 | 313 | 373 | 355 | 467 | 326 | 438 |
| Strain MD | | | | | | | | | |
| Force @ 50% | g/in | 350 | 446 | 335 | 415 | 387 | 530 | 356 | 505 |
| Strain MD | | | | | | | | | |
| Force @ 100% | g/in | 386 | 541 | 366 | 479 | 438 | 652 | 400 | 626 |
| Strain MD | | | | | | | | | |
| TEA MD | FtLb/ | 1,369 | 1,166 | 1,302 | 1,465 | 1,472 | 1,229 | 1,465 | 1,152 |
| | in² | | | | | | | | |
| Elmendorf Tear | g | 200 | 200 | 200 | 200 | 200 | 200 | 200 | 200 |
| MD Arm | | | | | | | | | |
| Elmendorf Tear | gf | 18.6* | 8.4* | 23.6* | 11* | 12.2* | 6* | 13* | 5.8* |
| MD | | | | | | | | | |
| Tensile Gauge TD | mil | 0.34 | 0.32 | 0.34 | 0.32 | 0.34 | 0.35 | 0.32 | 0.34 |
| Force @ Peak TD | g/in | 273 | 235 | 262 | 254 | 251 | 203 | 262 | 206 |
| Strain @ Peak TD | % | 521 | 503 | 401 | 471 | 505 | 481 | 463 | 392 |
| Force @ Break TD | g/in | 273 | 234 | 262 | 253 | 251 | 203 | 262 | 206 |
| Strain @ Break TD | % | 521 | 502 | 402 | 472 | 505 | 481 | 463 | 391 |
| Force @ Yield TD | g/in | 162 | 160 | 176 | 144 | 165 | 146 | 150 | 141 |
| Strain @ Yield TD | % | 23 | 21 | 27 | 26 | 23 | 22 | 26 | 25 |
| Force @ 5% | g/in | 94 | 98 | 89 | 71 | 102 | 89 | 77 | 71 |
| Strain TD | | | | | | | | | |
| Force @ 10% | g/in | 128 | 130 | 124 | 103 | 133 | 119 | 108 | 102 |
| Strain TD | | | | | | | | | |
| Force @ 25% | g/in | 165 | 163 | 173 | 142 | 168 | 148 | 149 | 141 |
| Strain TD | | | | | | | | | |
| Force @ 50% | g/in | 171 | 167 | 194 | 164 | 175 | 154 | 171 | 162 |
| Strain TD | | | | | | | | | |
| Force @ 100% | g/in | 168 | 166 | 191 | 167 | 172 | 154 | 173 | 166 |
| Strain TD | | | | | | | | | |
| TEA TD | FtLb/ | 1,060 | 1,028 | 879 | 982 | 1,015 | 821 | 993 | 715 |
| | in² | | | | | | | | |
| Elmendorf Tear | g | 1,600 | 1,600 | 1,600 | 1,600 | 1,600 | 1,600 | 1,600 | 1,600 |
| TD Arm | | | | | | | | | |
| Elmendorf Tear TD | gf | 328 | 340 | 266 | 333 | 333 | 263 | 282 | 292 |
| Dart Drop (26″) | g | 197 | 159 | 208 | 164 | 169 | 150 | 173 | 143 |
| § Slow Puncture- | gf | 207 | 242 | 237 | 274 | 244 | 262 | 225 | 275 |
| 1/4″ (D3) | | | | | | | | | |

### Example 6—Microporous Breathable Films with Exceptionally Low Basis Weights

Two microporous breathable films A3 and B3 having a structure CBBBC were prepared from the formulation XC3-22-2270.0 shown in Table 13. The physical properties of the resultant films are shown in Table 16.

In Table 16, the legend X/Y/Z is a shorthand nomenclature signifying pre-stretch/depth of engagement of IMG rolls/post-stretch. For example, the designation 50/085/0 corresponding to film A2 represents a 50%/50% pre-stretch, a depth of engagement of 85 mm, and 0% post-stretch. Surprisingly and unexpectedly, the films A2 and B2 exhibit high Dart Impact Strength (e.g., greater than 90 grams) in spite of exceptionally low basis weights (e.g., less than 9 gsm).

TABLE 16
Physical Properties of Skinned Microporous Breathable Films A3 and B3.

| X/Y/Z | | A3 | B3 |
|---|---|---|---|
| Physical Properties | Units | 50/085/0 | 50/085/30 |
| Gauge | mil | 0.23 | 0.19 |
| Basis Weight | g/m² | 8.42 | 7.03 |
| Density | g/cc | 1.4600 | 1.4288 |
| Emboss Depth | mil | 0.20 | 0.33 |
| Light Transmission | % | 51.1 | 51.9 |
| WVTR 100K | g/m²/day | 4185 | 5426 |
| Tensile Gauge MD | mil | 0.23 | 0.19 |
| Force @ Peak MD | g/in | 723 | 584 |
| Strain @ Peak MD | % | 182 | 95 |
| Force @ Break MD | g/in | 723 | 584 |
| Strain @ Break MD | % | 182 | 95 |
| Force @ Yield MD | g/in | 214 | 19 |
| Strain @ Yield MD | % | 9 | 0 |
| Force @ 5% Strain MD | g/in | 137 | 133 |
| Force @ 10% Strain MD | g/in | 219 | 235 |
| Force @ 25% Strain MD | g/in | 273 | 326 |
| Force @ 50% Strain MD | g/in | 308 | 398 |
| Force @ 100% Strain MD | g/in | 375 | 480 |
| TEA MD | FtLb/in² | 1,144 | 703 |
| Elmendorf Tear MD Arm | g | 200 | 200 |
| Elmendorf Tear MD | gf | 7.1* | 3.3* |
| Tensile Gauge TD | mil | 0.23 | 0.19 |
| Force @ Peak TD | g/in | 198 | 107 |
| Strain @ Peak TD | % | 501 | 425 |
| Force @ Break TD | g/in | 198 | 107 |
| Strain @ Break TD | % | 501 | 425 |
| Force @ Yield TD | g/in | 108 | 68 |
| Strain @ Yield TD | % | 28 | 23 |
| Force @ 5% Strain TD | g/in | 50 | 38 |
| Force @ 10% Strain TD | g/in | 74 | 55 |
| Force @ 25% Strain TD | g/in | 104 | 70 |
| Force @ 50% Strain TD | g/in | 122 | 81 |
| Force @ 100% Strain TD | g/in | 121 | 84 |
| TEA TD | FtLb/in² | 1,067 | 701 |
| Elmendorf Tear TD Arm | g | 1,600 | 1,600 |
| Elmendorf Tear TD | gf | 203 | 152 |
| Dart Drop (26″) | g | 102 | 93 |
| § Slow Puncture - ¼″ (D3) | gf | 155 | 154 |

### Example 7—Skinned Patterned Microporous Breathable Films

A skinned patterned microporous breathable film having a structure CBBBC was prepared from the formulation XC3-121-2289.0a shown in Table 17.

TABLE 17
Composition of XC3-121-2289.0a

| | | | Amount of |
|---|---|---|---|
| | Layer % | | Component |
| EXTRUDER | (Total) | COMPONENT | (Weight %) |
| B | 94 | SCC-86270 | 72 |
| | | (Standridge Color | |
| | | Corporation, CaCO₃) | |
| | | EXCEED LL3527 | 18 |
| | | (ExxonMobil, | |
| | | metallocene polyethylene | |
| | | resin) | |
| | | 640i | 10 |
| | | (DOW Chemical | |
| | | Company, low density | |
| | | polyethylene resin, | |
| | | LDPE) | |
| C | 3/3 | LD516.LN | 95 |
| (split) | | (ExxonMobil, low | |
| | | density polyethylene | |
| | | resin, LDPE) | |
| | | 15SAM03272 | 5 |
| | | (Standridge Color | |
| | | Corporation, Yachats | |
| | | Grey pigment in LDPE | |
| | | Carrier) | |

The composition of the CaCO₃-containing compound SCC-86270 in Table 17 is shown in Table 18.

TABLE 18
Composition of CaCO₃-Containing Compound SCC-86270 used in the
Formulation of Table 17.

| | Amount of Component |
|---|---|
| Component | (Weight %) |
| CaCO₃ Concentrate | 70 |
| LLDPE Carrier | 30 |

The film prepared from formulation XC3-121-2289.0a was subjected to CD IMG stretching (depth of engagement 0.08 inch) and had a basis weight of 16 gsm. The resultant film exhibited a seersucker appearance as shown in FIG. 7.

The overall thickness of the patterned microporous breathable film may be varied depending on the particular end use for which the film is manufactured. In illustrative embodiments, films in accordance with the present disclosure have a thickness that is less than typical thicknesses for patterned microporous breathable films. As described above, the beneficial properties of patterned microporous breathable films prepared in accordance with the present disclosure by using a vacuum box, air knife, and/or air blanket to cast a molten web against a chill roll may include one or more of reduced basis weight, increased Dart Impact Strength, increased strain at peak machine direction, and/or the like, and may allow the films to be used at a decreased gauge or thickness as compared to conventional patterned microporous breathable films. However, basis weights and thicknesses may be easily adjusted to fit a desired end use.

1. A process for making a patterned microporous breathable film comprising the steps of
extruding a composition comprising a polyolefin, an inorganic filler, and a pigment to form a molten web,
casting the molten web against a surface of a chill roll to form a quenched film, and
stretching the quenched film to form the patterned microporous breathable film.

2. The process of claim 1, wherein the patterned microporous breathable film comprises a pattern of alternating stripes.

3. The process of claim 1, wherein the patterned microporous breathable film comprises a pattern of alternating light and dark stripes.

4. The process of claim 1 wherein the casting comprises using an air knife, an air blanket, a vacuum box, or a combination thereof to cast the molten web against the surface of the chill roll.

5. The process of claim 1, wherein the molten web is cast against the surface of the chill roll under negative pressure by a vacuum box.

6. The process of claim 1, wherein the molten web is cast against the surface of the chill roll under positive pressure by an air knife.

7. The process of claim 1 wherein the polyolefin comprises polyethylene, polypropylene, or a combination thereof.

8. The process of claim 1, wherein the polyolefin comprises low density polyethylene, high density polyethylene, linear low density polyethylene, ultra-low density polyethylene, or a combination thereof.

9. The process of claim 1, wherein the polyolefin comprises linear low density polyethylene.

10. The process of claim 1, wherein the polyolefin comprises linear low density polyethylene, and wherein the linear low density polyethylene comprises a metallocene polyethylene.

11. The process of claim 1, wherein the inorganic filler comprises from about 30% to about 75% by weight of the patterned microporous breathable film.

12. The process of claim 11, wherein an average particle size of the inorganic filler is between about 0.1 microns and about 15 microns.

13. The process of claim 12, wherein the inorganic filler comprises an alkali metal carbonate, an alkaline earth metal carbonate, an alkali metal sulfate, an alkaline earth metal sulfate, or a combination thereof.

13. The process of claim 12, wherein the inorganic filler is selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof.

15. The process of claim 1, wherein the stretching comprises cross-direction (CD) stretching, intermeshing gear (IMG) stretching, machine direction (MD) stretching, or a combination thereof.

16. The process of claim 1, wherein the stretching comprises cross-directional intermeshing gear (CD IMG) stretching.

17. The process of claim 1, wherein the stretching comprises cross-directional intermeshing gear (CD IMG) stretching and subsequent machine direction (MD) stretching.

18. The process of claim 1, wherein at least a portion of the stretching is performed at a temperature of between about 60 degrees Fahrenheit and about 225 degrees Fahrenheit.

19. The process of claim 1, further comprising annealing the patterned microporous breathable film, wherein the annealing is performed at a temperature of between about 75 degrees Fahrenheit and about 225 degrees Fahrenheit.

20. The process of claim 1, wherein the patterned microporous breathable film has a basis weight of less than about 16 gsm.

21. The process of claim 1, wherein the patterned microporous breathable film has a basis weight of less than about 12 gsm.
